(19) United States
(12) Patent Application Publication
(10) Pub. No.: US 2020/0349496 A1
(43) Pub. Date: Nov. 5, 2020

(54) SYSTEM AND METHOD FOR CHECKING IN AND MONITORING TRANSPORTATION ASSETS

(71) Applicant: IGIT ENTERPRISES, INC., Guilford, CT (US)

(72) Inventors: Charles F. IRWIN, Guilford, CT (US); Jacob ALTLAND, Northford, CT (US); Danny KROEKER, Hutchinson, KS (US); Kyle STONE, Hamden, CT (US)

(21) Appl. No.: 16/853,235

(22) Filed: Apr. 20, 2020

Related U.S. Application Data
(60) Provisional application No. 62/842,903, filed on May 3, 2019.
(60) Provisional application No. 62/860,965, filed on Jun. 13, 2019.

(51) Int. Cl. G06Q 10/08

(52) U.S. Cl. CPC G06Q 10/083

(57) ABSTRACT

A system, method and storage medium for checking in and monitoring carrier vehicles associated with shipments. The system including a server, having a processor and a storage medium, a plurality of tasks and/or workflows, software executing on the server receiving data indicative of a carrier vehicle and a shipment, generating and/or loading a workflow, and initiating a text message to a mobile device of a driver of the carrier vehicle, and software executing on the server receiving at least one text message from the driver of the carrier vehicle indicative of a confirmation of an event, and recording at least one timestamp associated with the event confirmed by the at least one text message.

### TECHNICAL FIELD

This invention relates to freight transportation and logistics, and more specifically to a system and method for checking in and monitoring transportation assets and freight shipments.

### BACKGROUND

Approximately seventy percent of all freight in the United States is shipped by truck. Some shippers transport their goods using their own assets, often referred to as a private fleet. But many shippers rely on third parties, choosing to contract with asset-based carriers (that use their own assets to transport the goods) or with non-asset-based logistics service providers (that sub-contract with asset-based carriers, such as small carriers or owner-operators). It is also common for asset-based carriers to sub-contract with other asset-based carriers to meet peak demand. Regardless of the approach, shippers desire increased visibility to their shipments so that they can better monitor the location, estimated time of arrival, condition (such as temperature) and shipment events so that they can ensure on-time delivery, in-spec quality and control costs. Similarly, asset-based carriers desire visibility to their assets so that they can meet their customers' requirements, control costs and maximize utilization.

Many large asset-based carriers provide visibility to the real-time location of their assets (and the associated shipment) using telematics devices. The challenge of aggregating such data for many shipments with many carriers for ease of visibility by a single shipper has largely been solved. Unfortunately, real-time visibility for the shipper to shipment events, or to the driver's remaining hours of service (“HOS”) before his next break (required to accurately estimate the time of arrival), or to events at the receiving location, is not provided by currently available solutions on every shipment. Furthermore, these solutions do not provide visibility to shipments where the transport was arranged by a party other than the shipper, such as by a vendor supplying goods to the shipper (“vendor delivered order”) or by a customer picking up their order at the shipper (“customer pick-up”).

Location visibility is further diminished when the shipment is carried by a small asset-based carrier (without a telematic system or without the capability to submit data from their telematics system) or an owner-operator. Tracking solutions that rely on cell-tower triangulation are (or were) popular with drivers but are not accurate enough to precisely timestamp events and do not capture events. These solutions have been (or are at-risk of being) discontinued by the cellular service providers because of privacy concerns. Tracking solutions that rely on the driver to download a mobile application (so-called native “app”) onto his mobile device do provide real-time visibility to accurate GPS location data and to events. Many of the larger brokers have deployed their own mobile apps, hoping to embed a relationship with the driver (especially owner-operators). Unfortunately, driver adoption is low due to “app fatigue”; small carriers and owner-operators contract with many brokers and are simply overwhelmed by the complexity of having to use many mobile apps. Some leading “app-platform” brokers struggle to achieve over 50% adoption. Even if the driver does use the broker's mobile app, the event data provided by the app can be inaccurate. For example, one broker's app allows the driver to click the “arrived” button while still en-route because the app does not use a geo-fence to confirm that the driver has, in fact, arrived. Another broker's app uses a geo-fence to determine arrival time, which is inaccurate if the driver stops within the geo-fence to wait for their appointment (at, for example, a nearby truck stop).

Similarly, tracking solutions that rely on integrations with Electronic Logging Devices (“ELD”) provide real-time GPS location. But this approach also has limitations. ELD tracking provides limited event data, if any at all, as these devices are focused on driver HOS compliance. And, ELD data can be associated with the wrong shipment; it is difficult to know when to start and stop tracking (by calling the ELD service for tracking data), resulting in “overhang” where the calls for tracking data are started too early (and the assets are still assigned to the prior shipment) or are stopped too late (and the assets are now re-assigned to the next shipment). Carriers and drivers are increasingly concerned about this overhang. Carriers are concerned that others (who seek to monetize the data) might mis-use overhang “too early” data by assuming that the asset is “empty and available,” when, in fact, it has not yet completed its prior delivery. Drivers are, as before, concerned about “too late” overhang compromising their privacy. In addition, last minute tractor assignment changes can result in the ELD data being associated with the wrong shipment. Hand-offs or relays (from one driver/tractor to another) can also result in incorrect tracking; the first driver is now off the shipment (but still being tracked) and the second driver has not been properly associated with the shipment. Finally, some small carriers and many owner-operators use ELD's that are not connected to a cloud portal; data on such systems cannot be remotely accessed. When a tractor is equipped with a cloud-less ELD and the driver declines to use a downloadable app, the dispatcher has no choice but to track the shipment with an app-less triangulation solution (if available) or by “check calling” the driver by phone. As a result of these limitations, shippers do not enjoy accurate real-time visibility to location and events for all their shipments.

Visibility to events is desired to control costs, especially assessorial fees charged by the carrier for unplanned services. Fees imposed by carriers may include, for example, detention fees and demurrage fees. Detention refers to wait times associated with the tractor and driver and is typically measured in hours. Demurrage refers to fees associated with shipping containers and trailers left onsite and is typically measured in days or weeks. A typical contract between a shipper and its carrier allows for a specified amount of “free time” for detention and demurrage. If that time is exceeded, additional fees are incurred.

Carriers need precise timestamps for check-in (arrival) and check-out (departure) at a location in order to properly calculate the dwell time for an asset and then determine if a portion of this dwell time qualifies for a detention or demurrage assessorial charge. In many cases, carriers do not have reliable arrival and departure event timestamp information for the above reasons. Lacking this data, they often submit incorrect invoices. Invoices can also be incorrect due to mistakes or misrepresentation of detention and demurrage times. In addition, some carriers are also unable to apply shipper-specific rules (e.g., such as the detention clock starts on the later of the appointment time or actual arrival timestamp, but if actual arrival is after the grace period then the carrier is not eligible for detention) and thereby accurately calculate the assessorial fee. In some cases, a majority of a company's carrier detention invoices may be invalid resulting in potentially millions of dollars of overpayments.

Likewise, shippers need reliable and easily accessible check-in and check-out timestamps at every stop on a shipment to validate carrier assessorial invoices. Timestamps that are handwritten on shipping documents and filed away are not easily available for invoice validation. Similarly, timestamps captured electronically (e.g., in the warehouse or yard management system) can be inaccurate, difficult to retrieve and/or for the trailer only as these systems are typically trailer-centric (tractor-only gate events are often not even recorded). For example, one large receiver batch enters the data into their Warehouse Management System, and the time of data entry is incorrectly recorded as the shipment's arrival time. For another large shipper, it often takes 10 or more minutes to research the dwell time for a single tractor asset. In many cases, there is no check-in/out record; the empty trailer is not checked in (or out) or the bob-tail tractor is not checked-out because they are not associated with a shipment. It is, therefore, difficult for shippers to validate the detention and demurrage assessorial charges invoiced by the carriers. Frustrated by these limitations, shippers often resign themselves to simply auto-paying invoices if they are below a threshold value or “rubber-stamping” assessorial invoices as the approving managers do not have the time nor easy access to the appropriate data to research and validate the invoices. Some carriers take advantage of this behavior and submit even more invalid invoices.

Shippers also need accurate timestamps of delivery events at the buyer's receiving location (the consignee) to control consignee-related costs. For example, many sellers (shippers) offer Terms of Service (“TOS”) programs designed to incent desired behavior at the consignee. But many consignees apply the TOS discount to their payment on the shipper's invoice, even if they have not earned the discount. Accurate event data would enable the shipper to validate the discount and, if not earned, to request full payment from the buyer. Similarly, many consignee locations apply a penalty (often as large as $500) for late delivery to every payment, even if the delivery was made on-time. Again, accurate event data would enable the shipper to challenge the discount and hopefully receive payment in full. Finally, shippers do not have visibility to the delivery of goods if the customer arranges the transport (customer pick-up). Arguments often ensue when the customer inventory planner discovers that inventory is short because the CPU delivery did not arrive on time. Accurate event data at both the origin and delivery locations would avoid the dueling data by providing a verified “single version of the truth” (“SVOT”).

Shippers that hire third-party carriers to transport their goods often do not have easily accessible data, or no data at all, on the cycle times (and component events) to receive and unload, or to load and dispatch, shipments. Without such data, the shipper is unable to identify the process bottlenecks and implement effective corrective actions. Reducing cycle times is so important, especially when freight capacity is tight, that a supermarket chain in the United States is manually recording check-in and loading times in Excel spreadsheets. The Excel spreadsheets are then submitted to a project team for aggregation and analysis. This labor-intensive process publishes results two weeks after the event. A systematic, real-time process would enable this receiver to accelerate process improvements to reduce dwell time and be more driver friendly.

Some larger shipping locations have invested in a Yard Management System (“YMS”) and/or Warehouse Management System (“WMS”). These systems often include a gate management module that captures event timestamps for check-in and check-out. This functionality can include yard and door events, but with some exceptions. For example, they might not be able to timestamp when an incoming driver drops a trailer (full for unloading or empty for loading) in the yard. Furthermore, these systems provide no visibility to off-site events, such as remaining HOS for the driver, en-route location updates, and check-ins/check-outs at customer destinations. And, data in these systems is often available only to users located at the location. Even if YMS/WMS systems were capable of monitoring all on-site and off-site events and the data were visible to remote users (such as the carrier and receiver), these systems are expensive and require a lengthy specification, installation and configuration process and are, therefore, not justified for many locations, especially small and mid-size warehouses.

Asset-based carriers are required by U.S. law to equip their tractors with ELD's that comply with HOS regulations. Some carriers also equip their tractors with Electronic On-Board Recorders (“EOBR's”) that have been enhanced to comply with HOS regulations. These devices typically enable the driver to document events electronically for transmission to the carrier's headquarters. The best devices provide GPS validation of the submitted event. Data from the EOBR/ELD is often entered into the carrier's Transportation Management System (TMS) and used to run their business. The carrier then sends a shipment status update to the shipper, typically via the industry standard EDI 214 transaction. Unfortunately, EDI 214 messages often lag the actual delivery. For example, when a shipment delivers overnight, many carriers will not send the EDI 214 update to the shipper until the dispatcher has reviewed and approved the event in the morning. Similarly, many carriers will wait until they have received the Proof of Delivery document from the driver before reporting the arrival event via EDI 214. This is especially problematic for brokered shipments. EDI protocol is also dated and burdensome, and typically requires custom programming for every shipper to carrier pairing.

The HOS ELD requirement was expected by many in the industry to enable visibility to shipments carried by owner-operators by connecting the driver's ELD to a cloud host and then accessing data from the host. Unfortunately, many owner-operators have invested in ELD's for HOS compliance that are not connected to anything, as discussed above. In these simple systems (essentially a notebook on a tablet), the data is stored locally to provide an electronic record that the driver can show a police officer to confirm HOS compliance. Accordingly, location tracking and events for shipments with these owner-operators must be captured by alternate means, such as a “check call” from a dispatcher to a driver or the driver entering a transaction on a mobile tracking app with all the limitations described above.

Shippers also seek real-time visibility to intermodal shipments, but especially to the dray portion where a shipment container is transported the short distance from a rail terminus or ocean port to a receiving location. On this destination dray, visibility would enable the receiving location to prepare to receive and immediately unload a container with product that is needed promptly for out-bound shipments. Unfortunately, this visibility is difficult, if not impossible, to effect with current solutions because 1) the tractor cannot be associated with the container in advance as the pick-up sequence often is not or cannot be controlled and 2) the lag-time of making the association in real-time is often longer than the transit time. As a result, the receiver only gains visibility to the container (and its contents) on delivery. In addition, the current solutions do not provide the receiver with the opportunity to request that the dray driver prioritize critical containers.

Shippers also desire visibility to the temperature of particular shipments so that they can ensure product quality. Real-time visibility while en-route enables the shipper to take appropriate action to correct off-temperature shipments, such as calling the driver to start or reset the refrigeration unit or diverting the shipment for prompt transload if the refrigeration unit has failed. On receipt, visibility to the temperature history is necessary to ensure that the shipment has been handled in compliance with the Food Safety Modernization Act transport regulations (and not subjected to “temperature abuse”). If a deviation is detected, the receiving location can quarantine the product for quality testing. As with location, many large asset-based temperature-controlled carriers have invested in either refrigeration units that are capable of telematically submitting the “return air duct” temperature in real time or trailer tracking devices that monitor location and temperature, as well as other attributes such as motion, shock, humidity, and light. Integrations with the telematics provider or with the carrier's TMS then aggregates the data for single-site visibility for the shipper. Unfortunately, small-carriers and owner-operators do not typically have this capability. For these shipments, if a temperature deviation is suspected, the receiver often requires that the driver go to a nearby service center for a download of the temperature history before the product is unloaded or released from quarantine. Not only are downloads expensive, but out-bound shipments might be short-shipped while waiting for the product to be unloaded and/or released from quarantine. These same issues exist for other devices that measure the condition of the shipment, such as humidity, shock, or seal tamper devices.

There is also a desire to track individual trailers and shipments, though existing trailer telematic devices have not be widely adopted due to the expense and technical limitations. Devices that rely on an external power source (from the tractor or from solar panels) are expensive to purchase and to install. Battery powered devices are available but, unfortunately, the battery life is typically not sufficient to provide the frequency of tracking (at least hourly) required for meaningful tracking of a shipment. Such devices must, then, be recharged or replaced, with the associated costs. Improved devices and systems that can accurately track trailers and overcome these limitations are needed.

Despite attempts to capture information during the shipping process, problems with the accuracy and availability of data persist and remain a significant unsolved problem in the field. There is a desire to provide an improved system for checking in, checking out and monitoring shipments.

### SUMMARY OF THE INVENTION

An object of the present disclosure is to provide a system and method for reporting, in real-time, accurate location, condition, and/or event tracking data and estimated time of arrival basis the driver's remaining hours of service for any freight shipment with a driver, including dray shipments. A further object is to enable the generation of indisputable timestamps for check-in/out and loading/unloading events at a shipping or delivery location and beyond, and to deliver such time stamps and other information in real time. A further object is to provide visibility to shipments associated with a company, even if that company did not arrange for the transportation. A further object is to provide a solution that can be used by drivers for any shipment workflow without requiring a mobile app to be installed by the driver and that overcomes the privacy concerns in prior systems. A further object is to provide a solution that enables shippers to validate carrier assessorial invoices and automate the process of issuing payment on these invoices.

The present invention advantageously uses an automated and interactive text messaging or web user interface exchange with the driver to gather information concerning the shipment. In one embodiment, the system includes a server, at least one storage medium, and a software application accessible via a computer or mobile device. The software application may be accessible via a web browser, accessible by or stored on a desktop or laptop computer, and/or accessible via a mobile application or app. The software application performs a process which includes receiving data indicative of a carrier vehicle and a shipment (e.g., being dispatched to or arriving at a first location), and initiating a text message to a mobile device of a driver of the carrier vehicle, receiving at least one text message from the driver of the carrier vehicle indicative of a confirmation of an event, and recording at least one timestamp associated with the event confirmed by the at least one text message. In some embodiments, the text messages are from a workflow which defines an exchange of messages for each of a plurality of shipment types.

The data received by the system may be in a template, such as a dispatch template or a check-in template, that is submitted using the software application and triggers the text exchange with the driver based on workflow including a plurality of tasks. In one embodiment, the process is initiated by a dispatch template when the assets (tractor or truck, driver and, optionally, a trailer) are dispatched to pick-up a shipment at a location. In another embodiment, a shipper's attendant (at, for example, the site gate or shipping office) completes a check-in template using the application, e.g., on a personal computer or tablet, to initiate the process when the driver arrives at a location to pick-up or drop-off a shipment. In yet another embodiment, a driver initiates the process upon arrival by calling or texting a phone number at the gate which records the driver's mobile phone number, and in some cases the driver's location, and sends a message to the driver's phone to input information on the shipment. The system and/or application then initiates a text message (e.g., SMS or data message such as a WhatsApp message) exchange with the driver to generate timestamps for loading or unloading events while on-site. On departure, the attendant completes a simple check-out template, or the system automatically completes the check-out process on receipt of a departure text from the driver. The text exchange to capture the loading/unloading events provides an indisputable timestamp for the events and is easily implementable with minimal expense and set up.

The data collected and generated by the system can be viewed on the system's user interface (“UI”) or exported by a shipper or carrier representative to monitor on-site assets and take prompt action on any assets at-risk of incurring assessorial charges; quickly and easily validate carrier invoices; analyze unloading/loading cycle times at every stop; validate consignee TOS or late delivery deductions; and/or generate assessorial invoices. Using text messages rather than another mobile app on the driver's device ensures driver participation by avoiding the common “app fatigue” problem.

Embodiments of the present invention can be used by shippers to validate tractor and trailer detention assessorial charges, resulting in significant costs savings. Shippers can also analyze cycle times to reduce asset dwell times, thereby reducing/eliminating assessorial charges, and monitor the dwell time of assets that are still on-site (checked-in but not yet checked out).

Users of the system can identify assets that are at-risk of incurring detention charges and take action to avoid or minimize the potential assessorial charges. For example, when selecting an empty trailer from the trailer pool for pre-loading a shipment for later pick-up by the carrier, the user can quickly filter the display for that carrier's trailers and then sort by the “time on-site.” Always selecting the oldest trailer by this First In, First Out (“FIFO”) method drives down the average dwell time and avoids/reduces trailer demurrage costs. Similarly, tractors that are at risk of triggering detention charges are alerted on the Asset display for immediate action. Embodiments of the present invention may also be used by carriers to generate assessorial invoices based on reliable event timestamps. By using the present invention, shippers can also cost-effectively validate carrier assessorial invoices and also automate the process of issuing payment on these invoices, using a match-pay process and/or automatically issue payment when it does not exceed an approved amount.

One embodiment of the present invention is a system for checking in and monitoring transportation assets, including a server including a processor and a computer readable storage medium, a plurality of individual tasks arranged into a workflow and/or a plurality of predefined workflows stored on the storage medium, each task defining at least one or a series of automated messages for a shipment, and computer readable program instructions stored on the storage medium and read and executed by the processor for performing functional steps. The steps include receiving data indicative of a carrier vehicle and a shipment (e.g., including the shipment type), generating a workflow from a plurality of tasks (e.g. based on the shipment type), initiating, based on the workflow, a text message to a mobile device of a driver of the carrier vehicle, receiving at least one text message from the driver of the carrier vehicle indicative of a confirmation of an event, and recording at least one timestamp associated with the event confirmed by the at least one text message.

The system may further include an application (e.g., mobile application) accessible on a computing device (e.g., mobile device) at the location, the application presenting a check-in template on a user interface of the computing device and receiving, via the template, the data indicative of the carrier vehicle arriving at the location in the form of a user input. The application may also present a check-out template and receive, via the check-out template, data indicative of the carrier vehicle being checked out, wherein the check-in and the check-out templates include a plurality of fields at least a portion of which are prepopulated by the system. In some embodiments, the system may include an application executing on a computing device of a dispatcher, the application presenting a dispatch template on a user interface of the computing device and receiving, via the template, the data indicative of the carrier vehicle being dispatched to the location in the form of a user input.

The text messages sent and received by the system may be SMS messages and/or data messages and may be encrypted. In some embodiments, the data messages include location data associated with the mobile device of the driver. In some embodiments, the text message initiated to the mobile device of the driver includes a URL link to a webpage to receive responses from the driver, wherein the text messages from the driver are sent over the Internet via the webpage.

The system may also include software executing on the server processing the data indicative of the carrier vehicle arriving at the location and the text messages from the driver, generating and displaying interactive displays of the processed data to carriers and shippers, and/or generating and displaying interactive displays of the processed data to a party associated with assets of the shipment. The interactive displays may present data indicative of dwell times of assets, including one or more tractors, trucks or trailing equipment, that are sortable to indicate the assets at risk of incurring detention charges. The dwell times may be automatically adjusted for wait time at the check-in gate and/or any wait time not caused by the location. In some embodiments, the system converts the dwell times into approved assessorial charges and displays the approved assessorial charges in the interactive displays for payment.

In some embodiments, the system and steps executed thereby further includes a step of handing off the shipment to a second driver including receiving a text message from the driver including a mobile number of the second driver, initiating, based the workflow, a text message to a mobile device of the second driver of the carrier vehicle.

In some embodiments, the steps further include initiating, based on the workflow, a text message to the mobile device of the driver of the carrier vehicle a list of containers at a location, wherein the system associates the driver with each of the containers, and wherein the steps further includes receiving a text message from the driver of the carrier vehicle including a container number of a first one of the containers connected to the carrier vehicle.

The system may also include software executing on the server for transmitted data indicative of the event to a third-party tracking system, wherein the third-party tracking system initiates or discontinues tracking of the carrier vehicle based on the data indicative of the event.

In some embodiments, the system includes at least one sensor in the carrier vehicle in wireless connectivity with the mobile device, wherein the mobile device receives sensor data from the at least one sensor, wherein the steps performed by the computer readable program includes receiving the sensor data from the mobile device. The sensor data may be received from the mobile device continuously. In some embodiments, each of the text messages are a data message, wherein the text message initiated to the mobile device of the driver of the carrier vehicle upon receiving data indicative of a carrier vehicle arriving at a location or being dispatched to a location includes a URL link to a webpage to receive responses from the driver, wherein the sensor data is sent over the Internet via the webpage.

In some embodiments, the system further includes at least one sensor or tracking device in a trailer providing independent location information for the trailer, e.g., via signals sent over cellular networks and/or Wi-Fi hot spots. The tracking device may be reconfigurable over-the-air to turn on/off and/or change the frequency of location reporting based on the time stamps generated by the system. Using real-time shipment events (such as loaded and unloaded) trigger the reconfiguration of the device to only track when necessary to provide accurate data and save battery life.

Another embodiment of the present invention is a method for checking in and monitoring transportation assets, including steps of receiving, via an application executing on a computing device, a user input indicative of a carrier vehicle dispatched to and/or arriving at a location, generating a workflow from a plurality of tasks, and initiating a text message based on the workflow to a mobile device of a driver of the carrier vehicle.

In some embodiments, the text message prompts the driver to confirm that the carrier vehicle is engaging in a first event (e.g., positioned at a loading dock for loading) at the location. The method may further include receiving a responsive text message from the mobile device of the driver indicative of a confirmation that the carrier vehicle is engaging in the first event at the location, recording a timestamp associated with the carrier vehicle engaging in the first event, prompting, via a text message to the mobile device of the driver, the driver to confirm that the carrier vehicle is engaging in a second event (e.g., departing), receiving a responsive text message from the mobile device of the driver indicative of a confirmation that the carrier vehicle is engaging in the second event, and recording a timestamp associated with the carrier vehicle engaging in the second event. Further provided is a computer-readable storage medium having computer readable program instructions, the computer readable program instructions read and executed by at least one processor for performing the method.

In some embodiments, the method further includes a step of initiating a text message to the mobile device of the driver prompting the driver to confirm that the carrier vehicle has arrived at the location, and/or prompting, via a text message to the mobile device of the driver, the driver to confirm that the carrier vehicle is loaded, receiving a responsive text message from the mobile device of the driver indicative of the carrier vehicle being loaded, and recording a timestamp associated with the carrier vehicle being loaded.

The method may further include the steps of prompting, via a text message to the mobile device of the driver, the driver to confirm that the carrier vehicle is unloaded, receiving a responsive text message from the mobile device of the driver indicative of the carrier vehicle being unloaded, recording a timestamp associated with the carrier vehicle being unloaded.

In some embodiments, the method also includes steps of prompting, via a text or voice message to the mobile device of the driver, the driver to provide the driver's remaining hours of service, and receiving, via a responsive text or voice message from the mobile device of the driver, user input indicative of driver's remaining hours of service. The method may further prompt, via a text or voice message to the mobile device of the driver, the driver to confirm arrival at a destination, and receive, via a responsive text or voice message from the mobile device of the driver, user input indicative of a confirmation of arrival at the destination.

In some embodiments, the carrier vehicle is carrying a delivered shipment in which a shipper arranged for the transport of the shipment. The carrier vehicle may be carrying a customer pick-up (“CPU”) shipment in which a customer arranged for transport of a shipment or a vendor delivered order (“VDO”) in which a vendor arranged for the transport of the shipment containing ordered goods.

The method may further include steps of prompting, via a text or voice message to the mobile device of the driver, the driver to confirm departure from the destination, and receiving, via a responsive text or voice message from the mobile device of the driver, user input indicative of a confirmation of the departure from the destination. The method may also prompt the driver to provide an image indicating proof of delivery, and receive the image indicating proof of delivery. The method may also prompt the driver to identify an overage, shortage or damage (“OSD”) issue and initiate an OSD ticket for action and/or resolution by a shipper.

In some embodiments, the method further includes steps of prompting, via a text message to the mobile device of the driver, the driver to confirm arrival at a second destination, and receiving, via a responsive text message from the mobile device of the driver, user input indicative of a confirmation of arrival at the second destination, prompting, via a text or voice message to the mobile device of the driver, the driver to confirm departure from the second destination, and receiving, via a responsive text or voice message from the mobile device of the driver, user input indicative of a confirmation of the departure from the second destination.

The method may further include a step of handing off the shipment to a second driver including receiving a text message from the driver including a mobile number of the second driver, initiating, based on the workflow, a text message to a mobile device of the second driver of the carrier vehicle.

Some embodiments also enable handing off shipments to a second driver. The method may include a step of initiating, based on the workflow, a text message to the mobile device of the driver of the carrier vehicle a list of containers at a location, wherein the system associates the driver with each of the containers, and wherein the method further includes a step of receiving a text message from the driver of the carrier vehicle including a container number of a first one of the containers connected to the carrier vehicle.

Further provided is a system for checking in and monitoring transportation assets, including a server including a processor and a computer readable storage medium, a plurality of tasks and/or workflows stored on the storage medium, and computer readable program instructions stored on the storage medium and read and executed by the processor for performing steps. The steps include receiving data indicative of a carrier vehicle and a shipment, generating a workflow from the plurality of tasks or loading a predefined workflow, initiating a message, based on the workflow, to a mobile device of a driver of the carrier vehicle, the message including a URL link to a webpage to receive messages from the driver and data from the carrier vehicle, receiving at least one message from the driver of the carrier vehicle via the webpage indicative of a confirmation of an event, and recording at least one timestamp associated with the event confirmed by the at least one message.

In some embodiments, the data received from the carrier vehicle includes sensor data, wherein the mobile device wirelessly connects to at least one sensor in the carrier vehicle, wherein the mobile device receives the sensor data from the at least one sensor and transmits the sensor data via the webpage to the server. The at least one sensor may be one of a temperature sensor, a humidity sensor, a shock sensor, a light sensor or a door position (open or closed) sensor. The system may further include software executing on the server processing the sensor data, software executing on the server generating one or more interactive displays of the processed sensor data, and/or software executing on the server generating an alert when a value in the sensor data is outside of a predetermined value range.

### BRIEF DESCRIPTION OF THE DRAWINGS

The present disclosure will become more readily apparent from the specific description accompanied by the drawings.

FIG. 1 illustrates a system according to an exemplary embodiment of the present invention;

FIG. 2 illustrates an exemplary process employed by a system of the present invention;

FIG. 3 illustrates an exemplary process employed by a system of the present invention;

FIG. 4 illustrates an exemplary process employed by a system of the present invention;

FIGS. 5A-5B illustrate a check-in template generated by a system of the present invention;

FIGS. 6A-6B illustrate a display of an exemplary workflow initiated by a system of the present invention, and FIG. 6C illustrates a display of selectable tasks used in workflows initiated by the system;

FIGS. 7A-7B illustrate a dispatch template generated by a system of the present invention; and

FIGS. 8A-8B illustrate a check-out template generated by a system of the present invention;

FIGS. 9A and 9B illustrate assessorial displays generated by a system of the present invention;

FIGS. 9C-9D illustrate an on-site asset display generated by a system of the present invention; and

FIG. 10 illustrates a system according to an exemplary embodiment of the present invention.

FIG. 11 illustrates a system according to an exemplary embodiment of the present invention.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

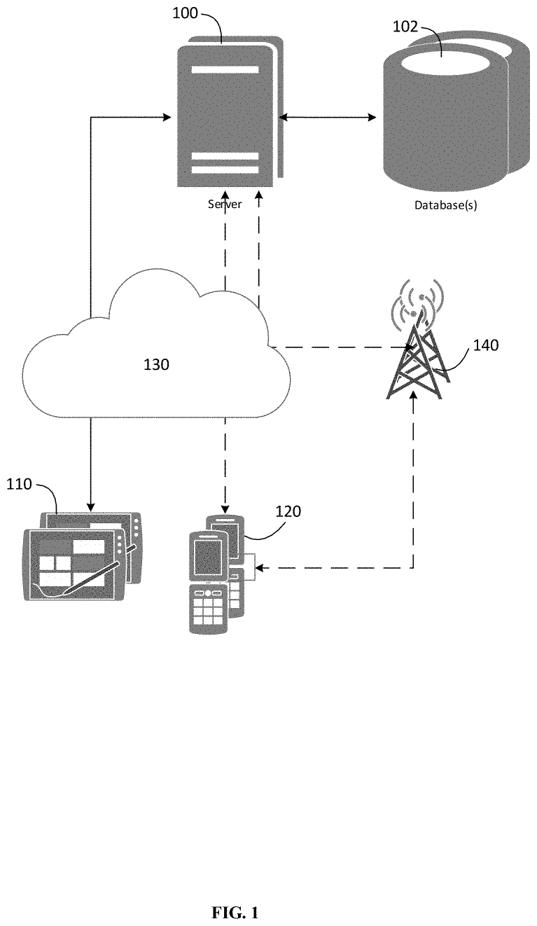

FIG. 1 illustrates a system according to an exemplary embodiment of the present invention. The system includes at least one server 100 and at least one computer readable storage medium 102. The system may further include one or more computing devices 110, such as a mobile device or tablet. The system may further include a plurality of mobile devices or phones 120 associated with drivers of transportation assets. The computing devices 110 and mobile devices or phones 120 are in communication with the system and the server 100 thereof via a network 130 such as the Internet and/or a cellular network 140.

The system includes one or more software applications. For example, the system may include at least one software application stored in the database 102 and/or running on the server 100 including computer readable program instructions. The system may be operated as a software as a service (“SaaS”) wherein users are given access to the software executing on the server 100 and database 102 via the Internet. In other embodiments, a particular user, such as carrier, broker or shipper, may directly control the server 100 and database 102 to run their own fleet of assets and/or shipments. The computing devices 110, e.g., used at shipping and receiving locations, may include a mobile application stored and executing thereon communicating data with the server 100 over the network 130. Alternatively, and/or in combination, the computing device 110 may access software executing on the server 100 over the network 130 via a website presented in a web browser. The mobile devices or phones 120 may communicate with the server 100 by text message (via a cellular network and/or the Internet) and/or may access software executing on the server 100 over the network 130 via a website presented in a web browser. In some embodiments, the mobile devices or phones 120 communicate with the server 100 by voice call.

In some embodiments, the at least one server 100 includes two or more servers remote to one another and/or managed by different entities. For example, the system may include a first server 100 or group of servers managed by an entity offering the SaaS, and a second server or group of servers managed by a third party for relaying text messages. In one embodiment, the second server interfaces with the cellular network 140 and relays SMS messages to the server 100 via the Internet.

The system according the present invention may be used for monitoring and checking-in and checking-out all means of transport. For example, the system may be used for delivered shipments where the seller/shipper arranges for the transport and for Customer Pick-Up shipments where the buyer/receiver arranges for the transport. The system may also be used for transport by Private Fleet where the party arranging transport uses their own assets.

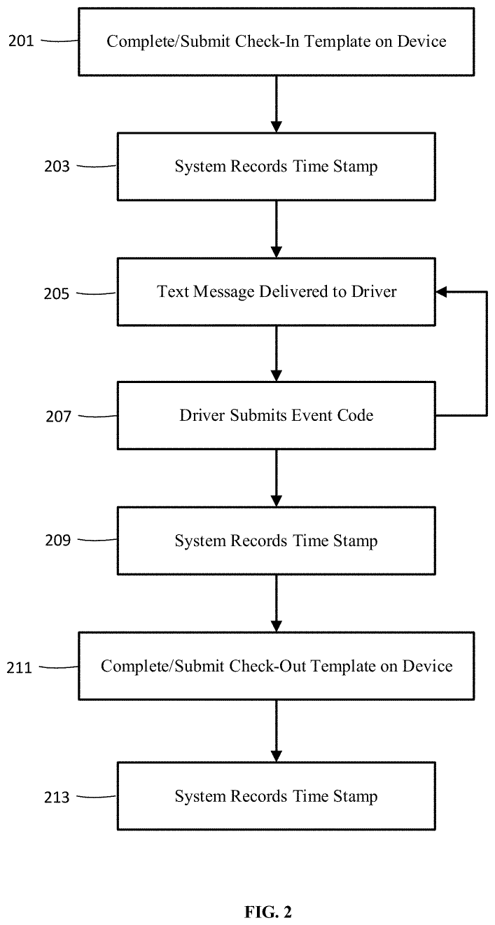

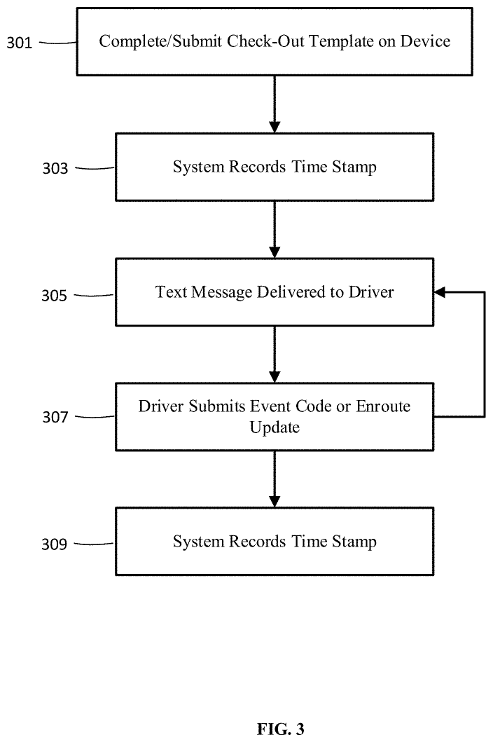

FIGS. 2-4 illustrate exemplary processes employed by the system shown in FIG. 1. The process illustrated in FIG. 2 includes a step 201 of completing and/or submitting a check-in template, generated by the system software, on a device. In this example, the template is a check-in template; however, other templates may be used to initiate the process as described herein. The check-in template includes a plurality of fields, at least a portion of which may be prepopulated by the system (e.g., including data concerning the carrier, shipper, receiver, driver, or shipment), concerning a shipment. For example, the check-in template may concern the arrival of a truck to pick up or drop off a shipment.

The check-in template may be completed by a shipping attendant at the location before or when the driver arrives. Alternatively, a check-in template or simplified version thereof may be completed by the driver on their mobile device upon arrival at the entrance or gate of the location. For example, a location may display a unique phone number at their gate for drivers to call (or text) upon arrival. The phone number is associated with the system described herein and records the driver's mobile phone number when dialed. In some embodiments, the call (or text) can be replaced with other means to capture the driver's mobile phone number (e.g., wirelessly pairing with a beacon, scanning a QR code, etc.). This call or other interaction triggers a message to the driver's phone requesting information about the shipment, tractor, and/or trailer. For drivers already in the system, at least a portion of the information may be prepopulated or otherwise not requested. The driver's location is known based on the phone number dialed and may also be confirmed (e.g., by GPS information from their mobile phone) when the driver responds with check-in information. The completed check-in template and/or a confirmation message may be displayed by the driver to the gate attendant and/or automatically sent to the gate attendant to gain entry. This embodiment simplifies the process of entering the location at the gate and avoids the necessity for the driver to exit the vehicle or even touch a public keypad. Exiting and reentering the vehicle takes time and, particularly in the year 2020, “social distancing” and limiting contact with other people and surfaces is desired and achieved by this embodiment. Once within the location to load or unload, the shipping attendant has all the necessary information and need not interact with driver.

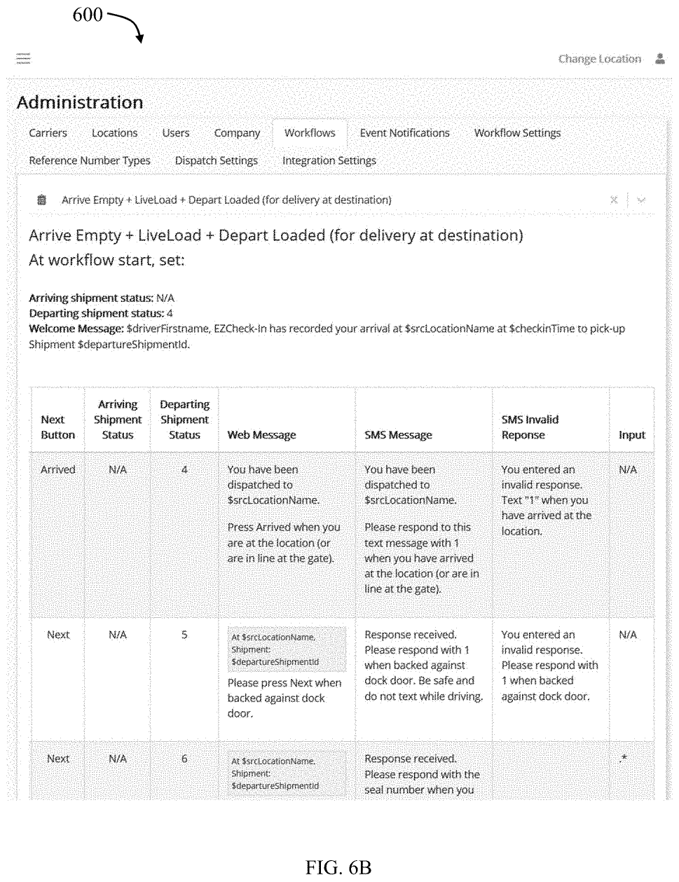

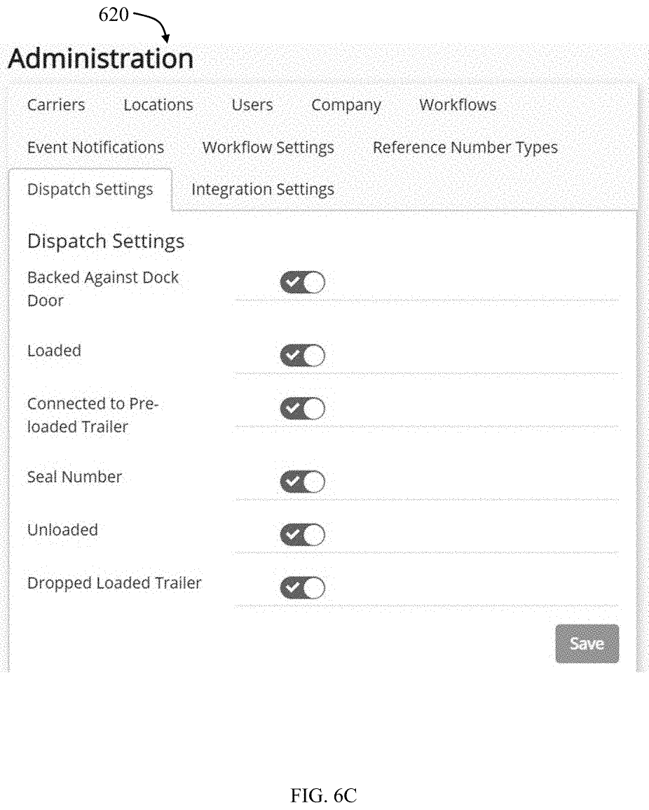

The template and/or the data therein is received and stored by the system. In some embodiments, step 201 includes the system receiving data via an electronic transfer from another system (e.g. API) in addition to or instead of receiving data in the template. The device may be a computing device such as a desktop computer, a laptop computer, or a tablet 110. As part of step 201, or in a shipment creation step prior thereto, a workflow for the shipment may be a predefined workflow (see, e.g., FIGS. 6A-B) selected or automatically determined by the system and loaded or a dynamically generated workflow including a plurality of tasks stored by the system (see, e.g., FIG. 6C) as explained in more detail below. In a step 203, the system optionally records a time stamp associated with the check-in template being submitted.

In a step 205, the system initiates an automated message to a mobile device 120 of the driver of the truck. The message may be, for example, an SMS text message or a data text message (e.g., WhatsApp, WeChat, iMessage, etc.). In some embodiments, such as when a data message such as a WhatsApp messaging app is used, the system may receive location information from the device 120.

In some embodiments, the initial text to the driver can optionally include a URL link to a webpage that the driver can access on their mobile device 120. In a preferred embodiment, the URL link can be accessed without needing to have an account or to log-in (e.g., the link has embedded authorities that enable restricted use of the website). The driver then clicks through the events on the webpage as each task is completed. A timestamp associated with each event is recorded by the system. In some embodiments, the system can access the location services on the driver's device 120 so that GPS location information is collected along with the event timestamp. The GPS information can then be used to validate that the driver is submitting events at the correct time (as they occur). Location data may be provided along with a text message sent by the driver. Location data may also be sent automatically in regular intervals. In some such embodiments, the webpage includes a “pause” function that allows the driver to stop the automatic transmission of location data (e.g., when on break and/or away from the truck). In alternative embodiments, the message is sent via a dedicated mobile application associated with the system and loaded on the mobile device 120 of the driver.

The automated message may prompt the driver for a response, e.g., to confirm whether an event has occurred. The driver may be presented with options for responding in the automated message. As described in more detail below, the messages and response options are derived from at least one workflow selected or generated for the shipment by a user, or automatically determined by the system, based on a shipment type. For example, in the case of a loaded trailer arriving for a live unload, the choices may include “text ‘9’ when backed against the dock,” “text ‘10’ when unloaded,” and “text ‘12’ when checked out.” In the case of an empty trailer arriving for a live load, the choices may include “text ‘5’ when backed against the dock,” “text <SealNumber> when loaded and sealed,” and “text ‘7’ when checked out.” In a step 207, the driver responds with an event code. Tracking the workflow allows the simplification of this process for the driver: just text ‘1’ in response to each workflow step.

In a step 209, the system records a time stamp indicative of the time of the driver's response and the associated event identified. In a step 211, a check-out template is completed on the device 110. The system then records a time stamp associated with the check-out (step 213).

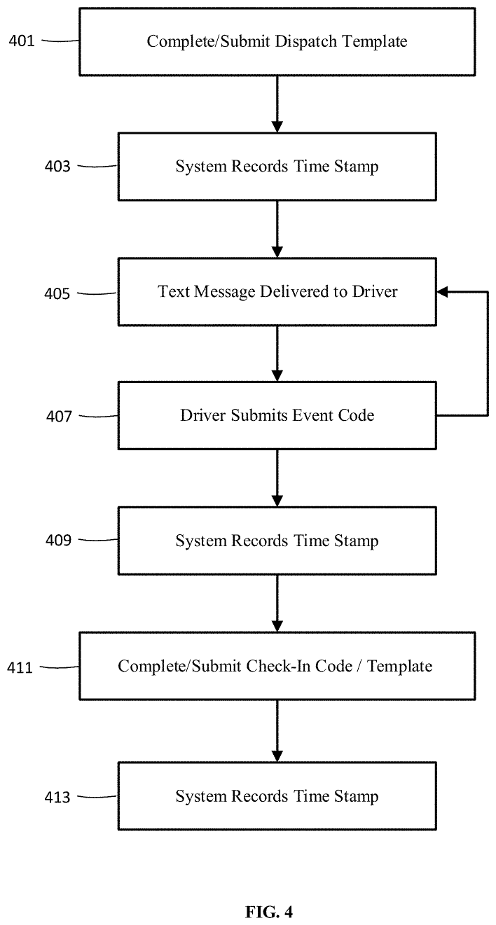

The communication process with the driver can extend after check-out from the origin (ship from) location. The process illustrated in FIG. 3 includes a step 301 of completing and/or submitting a check-out template on the device 110 and tracking and recording events which follow. In a step 303, the system records a time stamp associated with the check-out. Immediately or at some time thereafter, the system delivers one or a plurality of automated messages (e.g., SMS or data messages) to the mobile device 120 of the driver (step 305). In response, the driver provides an event code or other information or update (step 307). In some embodiments, the messages and responses after checkout, and particularly while the driver is driving, may be voice messages. For example, the system may initiate an automated call to the driver and pose questions and receive responses audibly (e.g., using voice recognition).

One automated message may ask the driver at or shortly after check-out to provide his/her remaining HOS clock until the next mandatory break. When capturing events by text (or by voice), every driver can participate without the need for additional hardware or mobile apps downloaded by the driver. No other tracking service can capture HOS for every shipment as the present invention can do. This data can be used to improve the calculation of the ETA at the destination (ship to) location.

At a specified time interval before arrival at the destination (e.g., as determined based on appointment or ETA), the system may automatically deliver a text message (or voice call) to the driver requesting confirmation that he/she is on-track to arrive on-time for the delivery at the destination. The ETA could be then appropriately revised and the ship to location informed. No other service can offer this feature for every shipment. Another automated message may ask the driver whether the shipment has been changed from a drop to a live unload, or vice versa.

During transit, the system can enable a “handoff”, where the driver transfers the shipment to another driver. In the exemplary embodiment, the system software prompts and/or provides a fillable form for the first driver to enter the mobile phone number for the second driver, who then receives a text message from the system and the tracking process continues with the second driver. With reference to FIG. 1, the system discontinues communicating with a first one of the mobile devices 120 and begins communicating with a second one of the mobile devices 120. Future messages in the workflow are sent to and received from the second driver.

On arrival at the destination location, the driver can trigger a “no-touch” automated check-in process, simply by texting the code for “Arrived at Destination” to the system. In some embodiments, the system requires the driver to text a location identifier to validate arrival. For example, the location may have a location code that is prominently displayed at the location (e.g., and changes periodically). For example, in one embodiment, the system includes a digital random number generator at each location presenting a code to be texted by the driver. In other embodiments, in which location information is delivered from the driver's phone 120 (e.g., using URL link or a data message with location information), such a validation technique is not necessary. In other embodiments as described above, the location displays a phone number to call which recognizes and records the driver's mobile phone number when dialed.

Shippers typically do not have visibility to deliveries that are picked-up by the customer's carrier. The customer might have visibility, but the shipper has no visibility after the shipment is dispatched from the shipper's ship from location. If, however, the shipper triggers the process according to the present invention, then the shipper can have visibility to delivery events (such as arrived, at dock, unloaded, departed) submitted by the CPU carrier driver at a destination location. Similarly, shippers (in the role of receiver) typically do not have visibility to deliveries to their manufacturing or warehouse facilities where the transport is arranged by the vendor (so called vendor delivered orders or “VDO”). If, however, the shipper requires that the vendor (or the carrier) trigger the process on dispatch to or arrival at the vendor's ship from location, then the shipper can have visibility to events at the vendors origin and at their receiving location submitted by the VDO carrier driver.

The system may also be used to capture the delivery plan (will the loaded trailer be “live” unloaded or “dropped” for later unloading) and any changes in this plan. For example, the driver may send a message to the system indicating that a drop shipment was converted (on arrival) to a live unload because (for example) the customer needed access to the inventory immediately.

The system may also inquire whether the driver has any overages, shortages and damage issues on delivery. Arriving on-time is good but could mean nothing if the shipment has an OSD issue. If an OSD issue is reported in response to an automated text, the system may automatically enable the driver to submit an OSD ticket for immediate resolution by the shipper. The shipper could then take immediate action to arrange for a replacement shipment for any shorted or damaged goods on the shipment.

When the URL link is used, the system may also include integration of the webpage and the ELD running on the driver's mobile device. With this approach, the system would likely be the only available solution capable of interacting with ELD's that are otherwise not connected to the internet, as is the case for many small carriers and owner-operators.

FIG. 4 illustrates an embodiment in which the process is initiated by a dispatcher, e.g., of a carrier or broker. Rather than wait for tracking to begin upon check-in at the first location, the process can begin at or even before assets are dispatched to pick-up the shipment. This gives additional visibility to the shipment that is generally not available in prior art systems. A dispatcher can initiate the process by completing a dispatch template (generated by the system and displayed on a computing device) identifying information in fillable fields about the shipment which is then submitted to the server 100 (step 401). The dispatch template may, for example, be completed in a web browser. As part of step 401, a workflow for the shipment may be generated, dynamically by the system from a plurality of tasks, or a predefined workflow may be selected or automatically determined by the system based on a shipment type selected as explained in more detail below.

In some embodiments, a time stamp is generated by the system when the dispatch template is submitted (step 403). In some embodiments, a dispatch template need not be manually filled by the dispatcher. For example, the template fields may be auto populated (with information stored in the databases or received via an electronic transfer from another system), or the dispatcher may authorize the carrier/broker's system to automatically transmit data to the server 100 without a template. As in the previous processes, an automatic text message is transmitted to the driver's mobile device (step 405). The driver can then respond with event codes, e.g., identifying when the driver begins driving to the origin (or pick-up) location, when the driver arrives, etc., and time stamps are generated (steps 407-409). Upon reaching a location, the driver may be checked in using a check-in template as described above. However, at locations that do not have access to the template, the driver may check-in and check-out solely by using event codes as described herein.

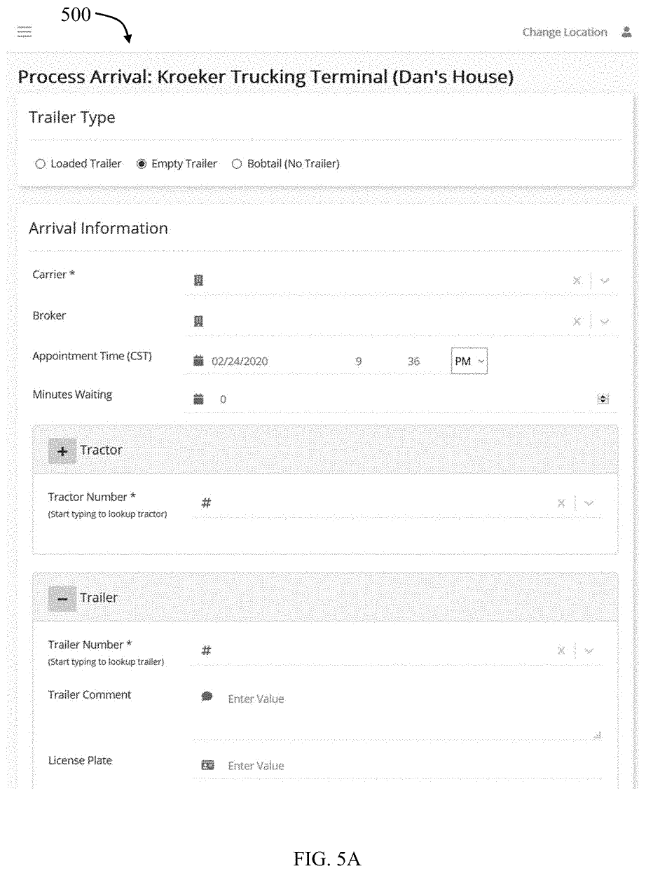

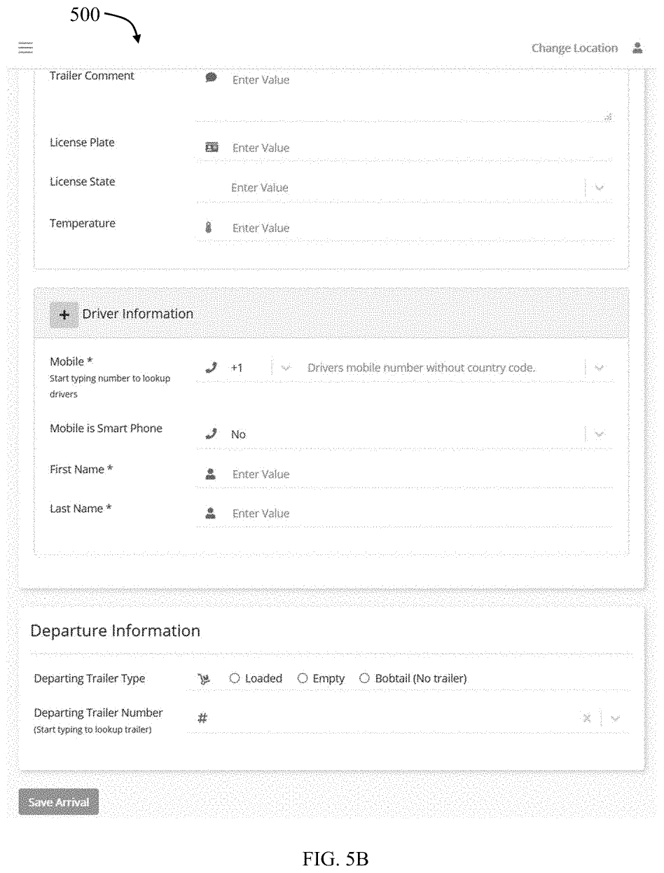

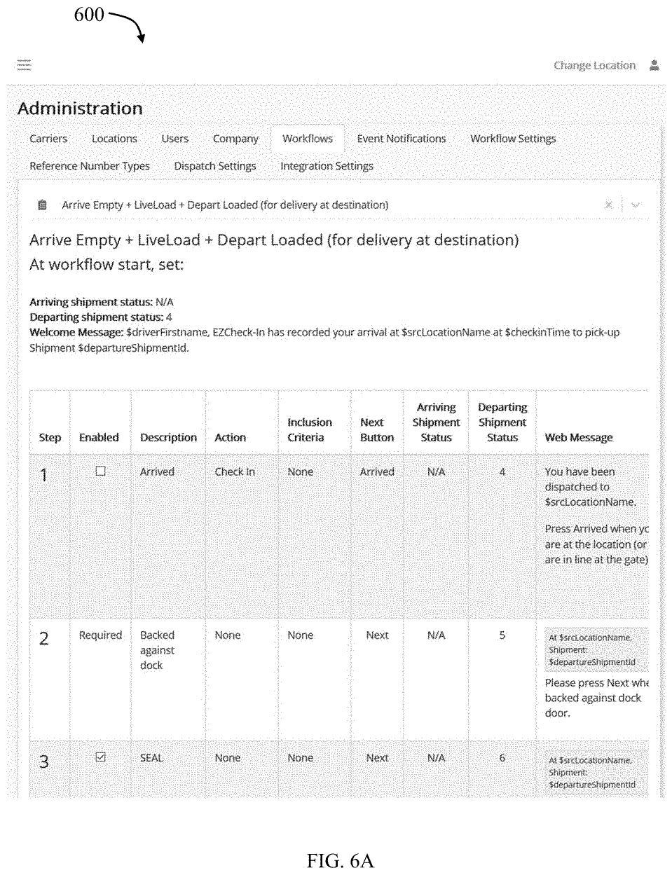

FIGS. 5A-5B illustrate an exemplary check-in or arrival template 500 generated by the system and used in the process. The template is accessible via an internet-enabled device such as the device 110. In the exemplary embodiment, the template is presented within a web browser executing on the device 110. The system according to the present invention does not require the use of any mobile apps by the drivers or any user of the system, however in some embodiments an app may be used, such as by a non-driver submitting the templates described herein. The system includes an asset check-in module.

Using the asset check-in module, a logged-in user (such as a shipping office clerk) completes and submits the check-in template 500 comprised of data entry fields for shipment, tractor, trailer and driver attributes. As indicated in FIG. 5A, the user may select whether the trailer is a “loaded trailer,” “an empty trailer,” or “bob-tail (no trailer). Based at least in part on this selection, the system may determine an appropriate workflow to implement based on a shipment type, either by assembling individually stored tasks to dynamically create the workflow or by identifying a predetermined workflow. Alternatively, the user may select a workflow from a list of workflows or individually select tasks to create a workflow. Additional options may be presented in other embodiments.

The system may pre-populate at least a portion of or all of the fields if data is available in the databases from prior transactions. In some embodiments, the template 500 is pre-populated with data received via an electronic transfer from another system. The driver section includes the driver's cell phone number. Upon completion, the template 500 is transmitted (e.g., via the Internet or cellular system) to the server 100 and/or storage 102. The system records a timestamp when the user submits the template 500.

The system, either at the server 100 or via an app executing on the device 110, then initiates a text exchange procedure with the driver. The system sends a text message (e.g., SMS text message or data message) to the driver, initiating an exchange with the driver to capture event timestamps as the driver executes his loading or unloading tasks. The system includes a library of a plurality of tasks and/or a plurality of workflows including tasks, e.g., stored in the databases 102, that are executed to send and receive messages with the driver. As shown in FIGS. 6A-6B, a plurality of workflows can be viewed and selected by a user in a display 600 generated by the application. In some embodiments, authorized users can modify and customize the workflows and/or create and store additional workflows or tasks within the workflows. In some embodiments, a workflow may be modified, manually by a user or automatically (e.g., based on events and/or responses), during the shipment.

In embodiments which include predefined workflows, the plurality of workflows may include “Arrive Loaded+Live Unload+Depart Empty,” “Arrive Loaded+Live Unload+Live Load+Depart Loaded,” “Arrive Loaded+Drop Loaded Trailer+Pick Pre-Loaded Trailer+Depart Loaded,” “Arrive Loaded+Drop Loaded Trailer+Pick Empty Trailer+Depart Empty,” “Arrive Loaded+Drop Loaded Trailer+Depart Bob-Tail,” “Arrive Empty+Live Load+Depart Loaded,” “Arrive Empty+Drop Empty Trailer+Pick Pre-Loaded Trailer+Depart Loaded,” “Arrive Empty+Drop Empty Trailer+Depart Bob-Tail,” “Arrive Empty+Drop Empty Trailer+Pick Empty Trailer+Depart Empty,” “Arrive Bob-Tail+Pick Pre-Loaded Trailer+Depart Loaded,” and “Arrive Bob-Tail+Empty Trailer+Depart Empty.” The system may load and initiate a workflow in response to a selection of a workflow by the user or automatically based on a determination by the system as to what workflow applies. These exemplary workflows, which are not exhaustive, are illustrated in the following tables.

TABLE 1
#1 Arrive Loaded + Live Unload + Depart Empty

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName]. |
| | | | | Press Arrived when | Respond to this text |
| | | | | you are at the location | message with 1 when |
| | | | | (or are in line at the | you have arrived at |
| | | | | gate). | the location (or are in |
| | | | | | line at the gate). |
| 2 | Backed | None | Next | At [LocationName], | Respond to this text |
| | against dock | | | Shipment: [ShipmentId]. | message with 1 when |
| | | | | Press Next when | backed against dock |
| | | | | backed against dock | door. |
| | | | | door. | |
| 3 | Unloaded | None | Next | At [LocationName], | Response received. |
| | | | | Shipment: [ShipmentId]. | Respond with 1 when |
| | | | | Press Next when you | you are unloaded. |
| | | | | are unloaded. | |
| 4 | Destination | Source | Depart | At [LocationName], | Response received. |
| | departure | Checkout | | Shipment: | Respond with 1 when |
| | | | | [ShipmentId]. | you have departed the |
| | | | | Press Depart when | site. |
| | | | | you have departed the | |
| | | | | site. | |
| 5 | Last | None | N/A | Shipment | Shipment #[ShipmentId] |
| | message | | | #[ShipmentId] was | was live unloaded |
| | | | | live unloaded at | at [LocationName] at |
| | | | | [LocationName] at | [CheckoutTime]. |
| | | | | [CheckoutTime]. | Your total Dwell |
| | | | | Your total Dwell | Time on site was |
| | | | | Time on site was | [DwellTime]. |
| | | | | [DwellTime]. | |

TABLE 2
#2 Arrive Loaded + Live Unload + Live Load + Depart Loaded

| | | | Next | | |
|---|---|---|---|---|---|
| Step | Description | Action | Button | Web Message | SMS Message |
| 1 | Arrived | Check In | Arrived | You have been dispatched to | You have been |
| | | | | [LocationName]. | dispatched to |
| | | | | Press Arrived when you are | [LocationName]. |
| | | | | at the location (or are in line | Respond to this text |
| | | | | at the gate). | message with 1 when |
| | | | | | you have arrived at |
| | | | | | the location (or are in |
| | | | | | line at the gate). |
| 2 | Backed | None | Next | At [LocationName], | Respond to this text |
| | against | | | Shipment: [ShipmentId]. | message with 1 when |
| | dock | | | Press Next when backed | backed against dock door. |
| | | | | against dock door. | Be safe and do |
| | | | | | not text while driving. |
| 3 | Source | None | Next | At [LocationName], | Response received. |
| | Unloaded | | | Shipment: [ShipmentId]. | Respond with 1 when |
| | | | | Press Next when you are | you are unloaded. |
| | | | | unloaded. | |
| 4 | Source | None | Next | At [LocationName], | Response received. |
| | Backed | | | Shipment: [ShipmentId]. | Respond with 1 when |
| | against | | | Press Next when you are | backed against dock |
| | dock | | | backed to dock door for | door for pickup. |
| | | | | pickup. | |
| 5 | SEAL | None | Next | At [LocationName], | Response received. |
| | | | | Shipment: | Respond with the seal |
| | | | | [DepartureShipmentId]. | number when you are |
| | | | | Respond with the seal | loaded, sealed and |
| | | | | number when you are | ready to pull away |
| | | | | loaded, sealed and ready to | from dock door. |
| | | | | pull away from dock door. | |
| 6 | Check-out | Source | Depart | At [LocationName], | Response received. |
| | complete | Checkout | | Shipment: | Respond with 1 when |
| | | | | [DepartureShipmentId]. | check-out is |
| | | | | Press Depart when check- | complete. |
| | | | | out is complete. | |
| 7 | Final | None | Next | Thank you for recording | Thank you for |
| | Message | | | your departure from | recording your |
| | | | | [LocationName] | departure from |
| | | | | | [LocationName] |
| 8 | Destination | Destination | Arrived | En-Route to | You dispatched at |
| | check-in | Arrival | | [destLocationName], | [CheckoutTime] with |
| | | | | Shipment: | Shipment |
| | | | | [DepartureShipmentId]. | #[DepartureShipmentId]. |
| | | | | You dispatched at | Please text 1 on |
| | | | | [CheckoutTime] with | arrival at |
| | | | | Shipment | [destLocationName]. |
| | | | | #[DepartureShipmentId]. | |
| | | | | Press Arrived on arrival at | |
| | | | | [destLocationName]. | |
| 9 | Destination | None | Next | At [destLocationName], | Response received. |
| | Backed | | | Shipment: | Respond with 1 when |
| | against | | | [DepartureShipmentId]. | backed against dock |
| | dock | | | Press Next when backed | door. |
| | | | | against dock door. | |
| 10 | Destination | None | Next | At [destLocationName], | Response received. |
| | Unloaded | | | Shipment: | Respond with 1 when |
| | | | | [DepartureShipmentId]. | you are unloaded. |
| | | | | Press Next when you are | |
| | | | | unloaded. | |
| 11 | Load | Drop | Next | At [destLocationName], | Response received. |
| | dropped | Trailer | | Shipment: | Respond with 1 when |
| | | | | [DepartureShipmentId]. | the load is dropped. |
| | | | | Press Next when the load is | |
| | | | | dropped. | |
| 12 | Destination | Destination | Depart | At [destLocationName], | Response received. |
| | departure | Departure | | Shipment: | Respond with 1 when |
| | | | | [DepartureShipmentId]. | you have departed the |
| | | | | Press Depart when you have | site. |
| | | | | departed the site. | |
| 13 | Final | None | N/A | Shipment Number | Shipment Number |
| | Message | | | #[DepartureShipmentId] | #[DepartureShipmentId] |
| | | | | was unloaded at | was unloaded at |
| | | | | receiver | receiver |
| | | | | [destLocationName] at | [destLocationName] |
| | | | | [destinationDeparture]. | at |
| | | | | Total dwell time on the | [destinationDeparture]. |
| | | | | receiver's site was | Total dwell time on |
| | | | | [destDwellTime]. | the receiver's site was |
| | | | | | [destDwellTime]. |

TABLE 3
#3 Arrive Loaded + Drop Loaded Trailer + Pick Pre-loaded Trailer + Depart Loaded

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName]. |
| | | | | Press Arrived when you | Respond to this text |
| | | | | are at the location (or | message with 1 when |
| | | | | are in line at the gate). | you have arrived at the |
| | | | | | location (or are in line |
| | | | | | at the gate). |
| 2 | Destination | Drop | Next | At [LocationName], | Respond to this text |
| | Load | Trailer | | Shipment: | message with 1 when |
| | Dropped | | | [ShipmentId]. | the load is dropped. |
| | | | | Press Next when the | Be safe and do not text |
| | | | | load is dropped. | while driving. |
| 3 | SEAL | Pick | Next | At [LocationName], | Response received. |
| | | Trailer | | Shipment: | Respond with the seal |
| | | | | [DepartureShipmentId]. | number when you have |
| | | | | Respond with the seal | picked up the next |
| | | | | number when you have | trailer and are ready to |
| | | | | picked up the next | leave. |
| | | | | trailer and are ready to | |
| | | | | leave. | |
| 4 | Check-out | Source | Depart | At [LocationName], | Response received. |
| | complete | Checkout | | Shipment: | Respond with 1 when |
| | | | | [DepartureShipmentId]. | check-out is complete. |
| | | | | Press Depart when | |
| | | | | check-out is complete. | |
| 5 | Final | None | Next | Thank you for | Thank you for |
| | Message | | | recording your | recording your |
| | | | | departure from | departure from |
| | | | | [LocationName] | [LocationName] |
| 6 | Destination | Destination | Arrived | En-Route to | You dispatched at |
| | check-in | Arrival | | [destLocationName], | [CheckoutTime] with |
| | | | | Shipment: | Shipment |
| | | | | [DepartureShipmentId]. | #[DepartureShipmentId]. |
| | | | | You dispatched at | Please text 1 on |
| | | | | [CheckoutTime] with | arrival at |
| | | | | Shipment | [destLocationName]. |
| | | | | #[DepartureShipmentId]. | |
| | | | | Press Arrived on arrival | |
| | | | | at [destLocationName]. | |
| 7 | Destination | None | Next | At [destLocationName], | Response received. |
| | Backed | | | Shipment: | Respond with 1 when |
| | against | | | [DepartureShipmentId]. | backed against dock |
| | dock | | | Press Next when you | door. |
| | | | | are backed to dock | |
| | | | | door. | |
| 8 | Destination | None | Next | At [destLocationName], | Response received. |
| | Unloaded | | | Shipment: | Respond with 1 when |
| | | | | [DepartureShipmentId]. | you are unloaded. |
| | | | | Press Next when you | |
| | | | | are unloaded. | |
| 9 | Load | Drop | Next | At [destLocationName], | Response received. |
| | dropped | Trailer | | Shipment: | Respond with 1 when |
| | | | | [DepartureShipmentId]. | the load is dropped. |
| | | | | Press Next when the | |
| | | | | load is dropped. | |
| 10 | Destination | Destination | Depart | At [destLocationName], | Response received. |
| | departure | Departure | | Shipment: | Respond with 1 when |
| | | | | [DepartureShipmentId]. | you have departed the |
| | | | | Press Depart when you | site. |
| | | | | have departed the site. | |
| 11 | Final | None | N/A | Shipment Number | Shipment Number |
| | Message | | | #[DepartureShipmentId] | #[DepartureShipmentId] |
| | | | | was unloaded at | was unloaded at |
| | | | | receiver | receiver |
| | | | | [destLocationName] at | [destLocationName] at |
| | | | | [destinationDeparture]. | [destinationDeparture]. |
| | | | | Total dwell time on the | Total dwell time on the |
| | | | | receiver's site was | receiver's site was |
| | | | | [destDwellTime]. | [destDwellTime]. |

TABLE 4
#4 Arrive Loaded + Drop Loaded Trailer + Pick Empty Trailer + Depart Empty

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName], |
| | | | | Press Arrived when | Respond to this text |
| | | | | you are at the location | message with 1 when |
| | | | | (or are in line at the | you have arrived at |
| | | | | gate). | the location (or are in |
| | | | | | line at the gate). |
| 2 | Load | Drop | Next | At [LocationName], | Respond to this text |
| | Dropped | Trailer | | Shipment: | message with 1 when |
| | | | | [ShipmentId]. | the load is dropped. |
| | | | | Press Next when the | Be safe and do not |
| | | | | load is dropped. | text while driving. |
| 3 | Trailer | Pick | Next | At [LocationName]. | Response received. |
| | Pickup | Trailer | | Press Next when you | Respond with 1 when |
| | | | | have picked up the | you have picked up |
| | | | | trailer: | the trailer: |
| | | | | #[departingTrailerNumber]. | #[departingTrailerNumber]. |
| 4 | Source | Source | Depart | At [LocationName], | Response received. |
| | departure | Checkout | | Press Depart when | Respond with 1 when |
| | | | | you have departed the | you have departed the |
| | | | | site. | site. |
| 5 | Last | None | N/A | Shipment | Shipment |
| | message | | | #[ShipmentId] was | #[ShipmentId] was |
| | | | | dropped at | dropped at |
| | | | | [LocationName] at | [LocationName] at |
| | | | | [CheckoutTime]. | [CheckoutTime]. |
| | | | | Your total Dwell | Your total Dwell Time |
| | | | | Time on site was | on site was |
| | | | | [DwellTime]. | [DwellTime]. |

TABLE 5
#5 Arrive Loaded + Drop Loaded Trailer + Depart Bob-tail

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName]. |
| | | | | Press Arrived when | Respond to this text |
| | | | | you are at the location | message with 1 when |
| | | | | (or are in line at the | you have arrived at |
| | | | | gate). | the location (or are in |
| | | | | | line at the gate). |
| 2 | Load | Drop | Next | At [LocationName], | Respond to this text |
| | Dropped | Trailer | | Shipment: | message with 1 when |
| | | | | [ShipmentId]. | the load is dropped. |
| | | | | Press Next when the | Be safe and do not |
| | | | | load is dropped. | text while driving. |
| 3 | Source | Source | Depart | At [LocationName], | Response received. |
| | departure | Checkout | | Press Depart when | Respond with 1 when |
| | | | | you have departed the | you have departed the |
| | | | | site. | site. |
| 4 | Last | None | N/A | Shipment | Shipment |
| | message | | | #[ShipmentId] was | #[ShipmentId] was |
| | | | | dropped at | dropped at |
| | | | | [LocationName] at | [LocationName] at |
| | | | | [CheckoutTime]. | [CheckoutTime]. |
| | | | | Your total Dwell | Your total Dwell |
| | | | | Time on site was | Time on site was |
| | | | | [DwellTime]. | [DwellTime]. |

TABLE 6
#6 Arrive Empty + Live Load + Depart Loaded

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName]. |
| | | | | Press Arrived when you | Respond to this text |
| | | | | are at the location (or | message with 1 when |
| | | | | are in line at the gate). | you have arrived at the |
| | | | | | location (or are in line |
| | | | | | at the gate). |
| 2 | Backed | None | Next | At [LocationName], | Response received. |
| | against | | | Shipment: | Respond with 1 when |
| | dock | | | [DepartureShipmentId] | backed against dock |
| | | | | Press Next when | door. |
| | | | | backed against dock | Be safe and do |
| | | | | door. | not text while driving. |
| 3 | SEAL | None | Next | At [LocationName], | Response received. |
| | | | | Shipment: | Respond with the seal |
| | | | | [DepartureShipmentId] | number when you are |
| | | | | Respond with the seal | loaded, sealed and |
| | | | | number when you are | ready to pull away from |
| | | | | loaded, sealed and | dock door. |
| | | | | ready to pull away from | |
| | | | | dock door. | |
| 4 | Check-out | Source | Depart | At [LocationName], | Response received. |
| | complete | Checkout | | Shipment: | Respond with 1 when |
| | | | | [DepartureShipmentId] | check-out is complete. |
| | | | | Press Depart when | |
| | | | | check-out is complete. | |
| 5 | Final | None | Next | Thank you for | Thank you for |
| | Message | | | recording your | recording your |
| | | | | departure from | departure from |
| | | | | [LocationName] | [LocationName] |
| 6 | Destination | Destination | Arrived | En-Route to | You dispatched at |
| | check-in | Arrival | | [destLocationName], | [CheckoutTime] with |
| | | | | Shipment: | Shipment |
| | | | | [DepartureShipmentId] | #[DepartureShipmentId]. |
| | | | | You dispatched at | Please text 1 on |
| | | | | [CheckoutTime] with | arrival at |
| | | | | Shipment | [destLocationName]. |
| | | | | #[DepartureShipmentId | |
| | | | | Press Arrived on arrival | |
| | | | | at [destLocationName]. | |
| 7 | Destination | None | Next | At [destLocationName], | Response received. |
| | Backed | | | Shipment: | Respond with 1 when |
| | against | | | [DepartureShipmentId] | backed against dock |
| | dock | | | Press Next when you | door. |
| | | | | are backed to dock | |
| | | | | door. | |
| 8 | Destination | None | Next | At [destLocationName], | Response received. |
| | Unloaded | | | Shipment: | Respond with 1 when |
| | | | | [DepartureShipmentId] | you are unloaded. |
| | | | | Press Next when you | |
| | | | | are unloaded. | |
| 9 | Load | Drop | Next | At [destLocationName], | Response received. |
| | dropped | Trailer | | Shipment: | Respond with 1 when |
| | | | | [DepartureShipmentId] | the load is dropped. |
| | | | | Press Next when the | |
| | | | | load is dropped. | |
| 10 | Destination | Destination | Depart | At [destLocationName], | Response received. |
| | departure | Departure | | Shipment: | Respond with 1 when |
| | | | | [DepartureShipmentId] | you have departed the |
| | | | | Press Depart when you | site. |
| | | | | have departed the site. | |
| 11 | Final | None | N/A | Shipment Number | Shipment Number |
| | Message | | | #[DepartureShipmentId] | #[DepartureShipmentId] |
| | | | | was unloaded at | was unloaded at |
| | | | | receiver | receiver |
| | | | | [destLocationName] at | [destLocationName] at |
| | | | | [destinationDeparture]. | [destinationDeparture]. |
| | | | | Total dwell time on the | Total dwell time on the |
| | | | | receiver's site was | receiver's site was |
| | | | | [destDwellTime]. | [destDwellTime]. |

TABLE 7
#7 Arrive Empty + Drop Empty Trailer + Pick Pre-loaded Trailer + Depart Loaded

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName]. |
| | | | | Press Arrived when you | Respond to this text |
| | | | | are at the location (or | message with 1 when |
| | | | | are in line at the gate). | you have arrived at the |
| | | | | | location (or are in line |
| | | | | | at the gate). |
| 2 | Drop | Drop | Next | At [LocationName], | Response received. |
| | Empty | Trailer | | Press Next when you | Respond with 1 when |
| | Trailer | | | have dropped the empty | you have dropped the |
| | | | | trailer. | empty trailer. |
| | | | | | Be safe |
| | | | | | and do not text while |
| | | | | | driving. |
| 3 | Connected | Pick | Next | At [LocationName], | Response received. |
| | to Pre- | Trailer | | Shipment: | Respond with 1 when |
| | loaded | | | [DepartureShipmentId]. | you have connected to |
| | Trailer | | | Press Next when you | the pre-loaded trailer. |
| | | | | have connected to the | |
| | | | | pre-loaded trailer. | |
| 4 | SEAL | None | Next | At [LocationName], | Response received. |
| | | | | Shipment: | Respond with the seal |
| | | | | [DepartureShipmentId]. | number. |
| | | | | Respond with the seal | |
| | | | | number. | |
| 5 | Check-out | Source | Depart | At [LocationName], | Response received. |
| | complete | Checkout | | Shipment: | Respond with 1 when |
| | | | | [DepartureShipmentId] | check-out is complete. |
| | | | | Press Depart when | |
| | | | | check-out is complete. | |
| 6 | Final | None | Next | Thank you for | Thank you for |
| | Message | | | recording your | recording your |
| | | | | departure from | departure from |
| | | | | [LocationName] | [LocationName] |
| 7 | Destination | Destination | Arrived | En-Route to | You dispatched at |
| | check-in | Arrival | | [destLocationName], | [CheckoutTime] with |
| | | | | Shipment: | Shipment |
| | | | | [DepartureShipmentId] | #[DepartureShipmentId]. |
| | | | | You dispatched at | Please text 1 on |
| | | | | [CheckoutTime] with | arrival at |
| | | | | Shipment | [destLocationName]. |
| | | | | #[DepartureShipmentId] | |
| | | | | Press Arrived on arrival | |
| | | | | at [destLocationName]. | |
| 8 | Destination | None | Next | At [destLocationName], | Response received. |
| | Backed | | | Shipment: | Respond with 1 when |
| | against | | | [DepartureShipmentId] | backed against dock |
| | dock | | | Press Next when you | door. |
| | | | | are backed to dock | |
| | | | | door. | |
| 9 | Destination | None | Next | At [destLocationName], | Response received. |
| | Unloaded | | | Shipment: | Respond with 1 when |
| | | | | [DepartureShipmentId] | you are unloaded. |
| | | | | Press Next when you | |
| | | | | are unloaded. | |
| 10 | Load | Drop | Next | At [destLocationName], | Response received. |
| | dropped | Trailer | | Shipment: | Respond with 1 when |
| | | | | [DepartureShipmentId] | the load is dropped. |
| | | | | Press Next when the | |
| | | | | load is dropped. | |
| 11 | Destination | Destination | Depart | At [destLocationName], | Response received. |
| | departure | Departure | | Shipment: | Respond with 1 when |
| | | | | [DepartureShipmentId] | you have departed the |
| | | | | Press Depart when you | site. |
| | | | | have departed the site. | |
| 12 | Final | None | N/A | Shipment Number | Shipment Number |
| | Message | | | #[DepartureShipmentId] | #[DepartureShipmentId] |
| | | | | was unloaded at | was unloaded at |
| | | | | receiver | receiver |
| | | | | [destLocationName] at | [destLocationName] at |
| | | | | [destinationDeparture]. | [destinationDeparture]. |
| | | | | Total dwell time on the | Total dwell time on the |
| | | | | receiver's site was | receiver's site was |
| | | | | [destDwellTime]. | [destDwellTime]. |

TABLE 8
#8 Arrive Empty + Drop Empty Trailer + Depart Bob-tail

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName]. |
| | | | | Press Arrived when | Respond to this text |
| | | | | you are at the location | message with 1 when |
| | | | | (or are in line at the | you have arrived at |
| | | | | gate). | the location (or are in |
| | | | | | line at the gate). |
| 2 | Drop Empty | Drop | Next | At [LocationName]. | Response received. |
| | Trailer | Trailer | | Press Next when you | Respond with 1 when |
| | | | | have dropped the | you have dropped the |
| | | | | empty trailer. | empty trailer. |
| | | | | | Be safe |
| | | | | | and do not text while |
| | | | | | driving. |
| 3 | Check-Out | Source | Depart | At [LocationName], | Response received. |
| | Complete | Checkout | | Press Depart when | Respond with 1 when |
| | | | | check-out is | check-out is |
| | | | | complete. | complete. |
| 4 | Final | None | N/A | Total dwell time on | Total dwell time on |
| | Message | | | site was [DwellTime] | site was [DwellTime] |

TABLE 9
#9 Arrive Empty + Drop Empty Trailer + Pick Empty Trailer + Depart Empty

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName]. |
| | | | | Press Arrived when | Respond to this text |
| | | | | you are at the location | message with 1 when |
| | | | | (or are in line at the | you have arrived at |
| | | | | gate). | the location (or are in |
| | | | | | line at the gate). |
| 2 | Drop Empty | Drop | Next | At [LocationName]. | Response received. |
| | Trailer | Trailer | | Press Next when you | Respond with 1 when |
| | | | | have dropped the | you have dropped the |
| | | | | empty trailer. | empty trailer. |
| | | | | | Be safe |
| | | | | | and do not text while |
| | | | | | driving. |
| 3 | Trailer | None | Next | At [LocationName], | Response received. |
| | Pickup | | | Press Next when you | Respond with 1 when |
| | | | | have picked up the | you have picked up |
| | | | | trailer: | the trailer: |
| | | | | #[departingTrailer | #[departingTrailer |
| | | | | Number]. | Number]. |
| 4 | Check-out | Source | Depart | At [LocationName], | Response received. |
| | complete | Checkout | | Press Depart when | Respond with 1 when |
| | | | | check-out is | check-out is |
| | | | | complete. | complete. |
| 5 | Final | None | N/A | Total dwell time on | Total dwell time on |
| | Message | | | site was [DwellTime] | site was [DwellTime] |

TABLE 10
#10 Arrive Bob-tail + Pick Pre-loaded Trailer + Depart Loaded

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName]. |
| | | | | Press Arrived when you | Respond to this text |
| | | | | are at the location (or | message with 1 when |
| | | | | are in line at the gate). | you have arrived at the |
| | | | | | location (or are in line |
| | | | | | at the gate). |
| 2 | Connected | Pick | Next | At [LocationName], | Respond with 1 when |
| | to Pre- | Trailer | | Shipment: | you have connected to |
| | loaded | | | [DepartureShipmentId]. | the pre-loaded trailer. |
| | Trailer | | | Press Next when you | |
| | | | | have connected to the | |
| | | | | pre-loaded trailer. | |
| 3 | SEAL | None | Next | At [LocationName], | Respond with the seal |
| | | | | Shipment: | number. |
| | | | | [DepartureShipmentId]. | |
| | | | | Response received. | |
| | | | | Respond with the seal | |
| | | | | number. | |
| 4 | Check-out | Source | Depart | At [LocationName], | Response received. |
| | complete | Checkout | | Shipment: | Respond with 1 when |
| | | | | [DepartureShipmentId] | check-out is complete. |
| | | | | Press Depart when | |
| | | | | check-out is complete. | |
| 5 | Final | None | Next | Thank you for | Thank you for |
| | Message | | | recording your | recording your |
| | | | | departure from | departure from |
| | | | | [LocationName] | [LocationName] |
| 6 | Destination | Destination | Arrived | En-Route to | You dispatched at |
| | check-in | Arrival | | [destLocationName], | [CheckoutTime] with |
| | | | | Shipment: | Shipment |
| | | | | [DepartureShipmentId] | #[DepartureShipmentId]. |
| | | | | You dispatched at | Please text 1 on |
| | | | | [CheckoutTime] with | arrival at |
| | | | | Shipment | [destLocationName]. |
| | | | | #[DepartureShipmentId] | |
| | | | | Press Arrived on arrival | |
| | | | | at [destLocationName]. | |
| 7 | Destination | None | Next | At [destLocationName], | Response received. |
| | Backed | | | Shipment: | Respond with 1 when |
| | against | | | [DepartureShipmentId] | backed against dock |
| | dock | | | Press Next when you | door. |
| | | | | are backed to dock | |
| | | | | door. | |
| 8 | Destination | None | Next | At [destLocationName], | Response received. |
| | Unloaded | | | Shipment: | Respond with 1 when |
| | | | | [DepartureShipmentId] | you are unloaded. |
| | | | | Press Next when you | |
| | | | | are unloaded. | |
| 9 | Load | Drop | Next | At [destLocationName], | Response received. |
| | dropped | Trailer | | Shipment: | Respond with 1 when |
| | | | | [DepartureShipmentId] | the load is dropped. |
| | | | | Press Next when the | |
| | | | | load is dropped. | |
| 10 | Destination | Destination | Depart | At [destLocationName], | Response received. |
| | departure | Departure | | Shipment: | Respond with 1 when |
| | | | | [DepartureShipmentId] | you have departed the |
| | | | | Press Depart when you | site. |
| | | | | have departed the site. | |
| 11 | Final | None | N/A | Shipment Number | Shipment Number |
| | Message | | | #[DepartureShipmentId] | #[DepartureShipmentId] |
| | | | | was unloaded at | was unloaded at |
| | | | | receiver | receiver |
| | | | | [destLocationName] at | [destLocationName] at |
| | | | | [destinationDeparture]. | [destination Departure]. |
| | | | | Total dwell time on the | Total dwell time on the |
| | | | | receiver's site was | receiver's site was |
| | | | | [destDwellName]. | [destDwellName]. |

TABLE 11
#11 Arrive Bob-tail + Pick Empty Trailer + Depart Empty

| | | | Next | | |
|---|---|---|---|---|---|
| Step | Description | Action | Button | Web Message | SMS Message |
| 1 | Arrived | Check In | Arrived | You have been | You have been |
| | | | | dispatched to | dispatched to |
| | | | | [LocationName]. | [LocationName]. |
| | | | | Press Arrived when | Respond to this text |
| | | | | you are at the location | message with 1 when |
| | | | | (or are in line at the | you have arrived at |
| | | | | gate). | the location (or are in |
| | | | | | line at the gate). |
| 2 | Trailer | Pick | Next | At [LocationName]. | Response received. |
| | Pickup | Trailer | | Press Next when you | Respond with 1 when |
| | | | | have picked up the | you have picked up |
| | | | | trailer. | the trailer. |
| | | | | | Be safe |
| | | | | | and do not text while |
| | | | | | driving. |
| 3 | Check-out | Source | Depart | At [LocationName]. | Response received. |
| | complete | Checkout | | Press Depart when | Respond with 1 when |
| | | | | check-out is | check-out is |
| | | | | complete. | complete. |
| 4 | Final | None | N/A | Total dwell time on | Total dwell time on |
| | Message | | | site was [DwellTime] | site was [DwellTime] |

In other embodiments, the database 102 includes a plurality of tasks, such as the individual tasks identified in the exemplary workflows above, which are dynamically assembled into a workflow for a given shipment as the shipment is initiated. For example, FIG. 6C shows exemplary tasks which may be stored in the database 102, each including a data record defining a text exchange or other action. Creating workflows dynamically as the shipment is created allows for a limitless variety of options. Most notably, rather than just tracking from an origin to a destination, a shipment may be set up in the system to have multiple stops, driver transfers, equipment transfers (e.g., changing tractor, trailer, etc.), and intermodal transfers (e.g., truck to rail or ocean vessel). The shipment may also be set up with multiple consignees and/or multiple customers.

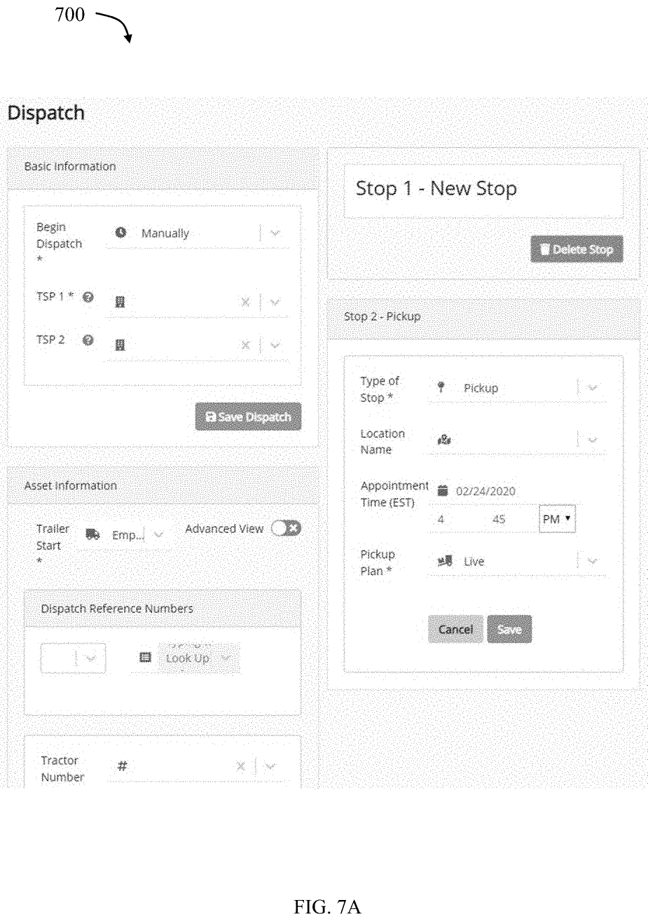

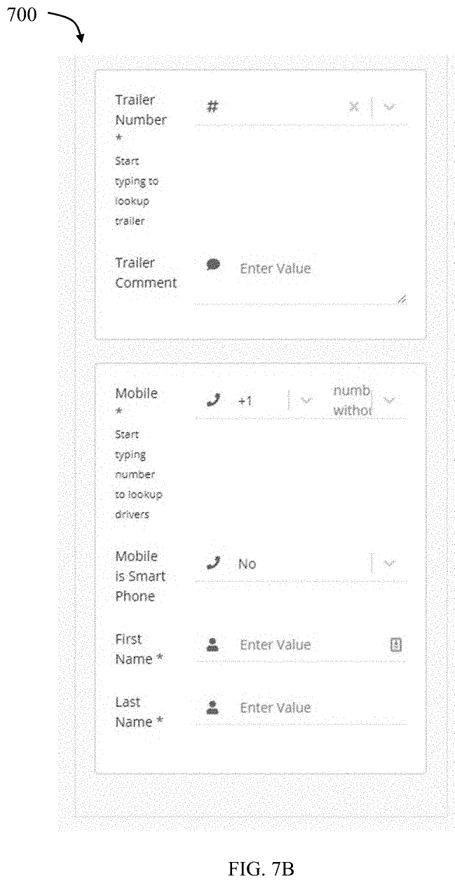

Based on the information provided when the shipment is set up, the system generates a custom workflow including tasks to accommodate each aspect of the shipment. For example, FIGS. 7A-7B show a dispatch template 700 that may be generated by and used with the system according to the present invention. As shown, a dispatcher can create a shipment and add multiple stops.

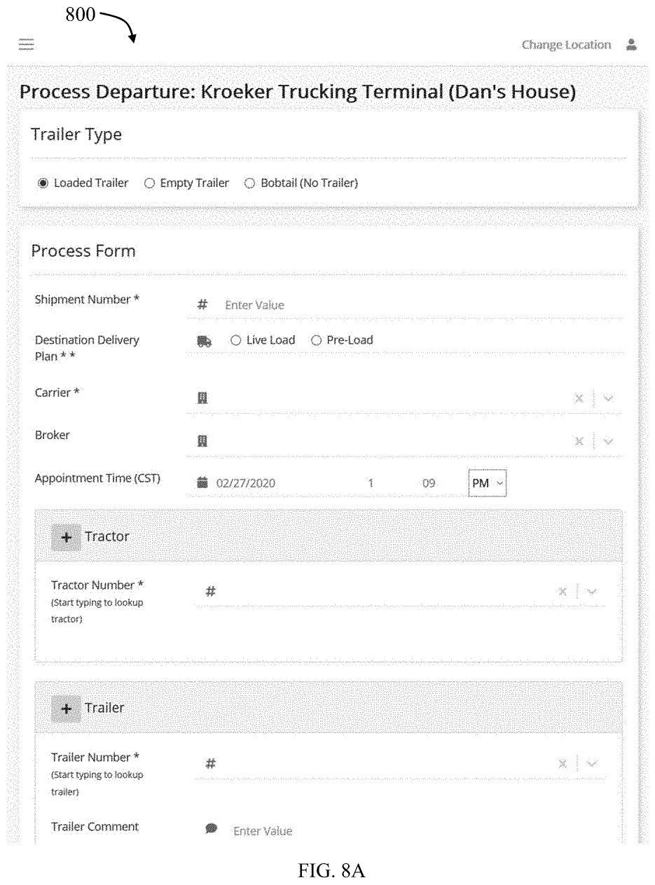

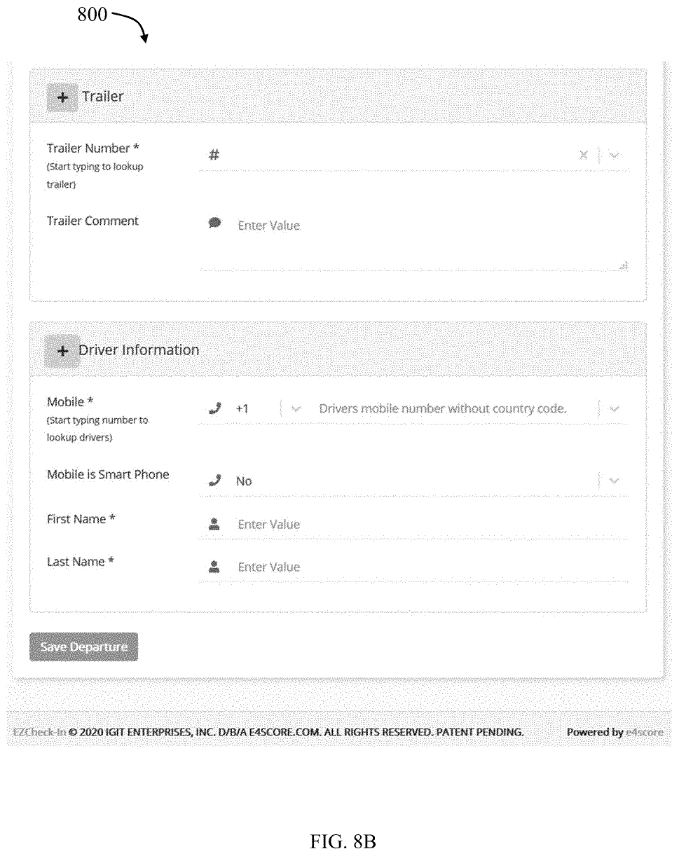

When it is time for the asset to check-out, a logged-in user (can be a different user) completes and submits a check-out template comprised of data entry fields for shipment, tractor, trailer and driver attributes. FIGS. 8A-8B illustrate a departure check-out template 800 generated by the system. The system pre-populates any field for which information is available from the check-in event. The system records the timestamp when the user submits the template.

The system according to the present invention collects data from the templates and/or interaction with driver and processes the data. The system may further transmit and/or present the data to interested parties, such as the shipper, the carrier, or to any party associated with the assets and their shipment, including the warehouse operators or brokers. For example, the system may generate interactive displays (e.g., in real time) indicating the location and status of assets and/or the events that have taken place or are pending. The system may further generate interactive displays indicative of dwell times of assets, e.g., including trucks and trailing equipment (e.g., trailers and containers). Such displays may be transmitted, e.g., in real time, via the network, to computing devices 110 associated with the shippers, carriers, or other interested parties. The displays may be presented in a web-based platform accessible by some or all of the interested parties to view real-time information on the shipment. In some embodiments, parties may directly interact with the driver (e.g., to receive updates or instruct changes) through the platform by sending and receiving text messages to the driver's mobile phone through the web-based platform.

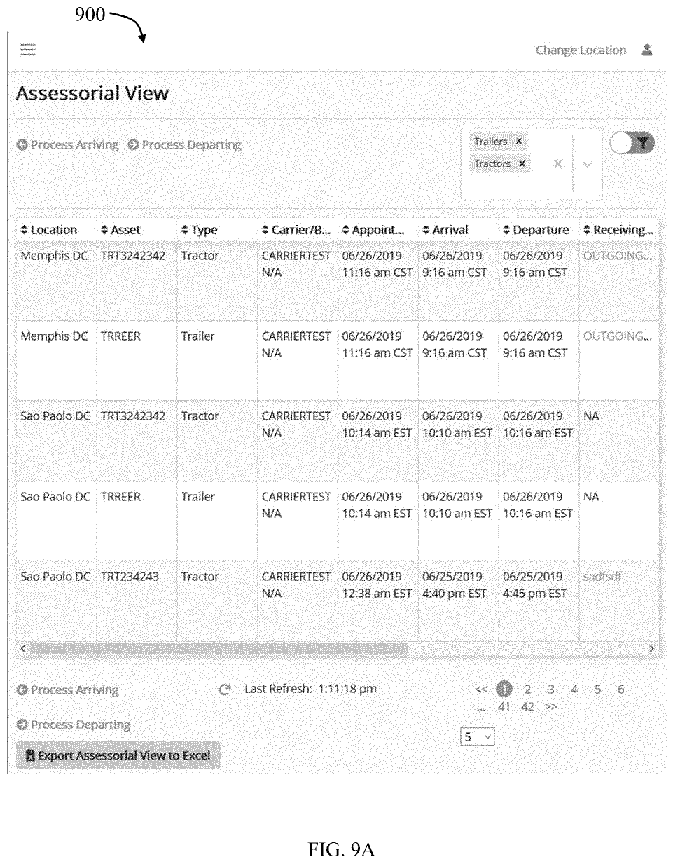

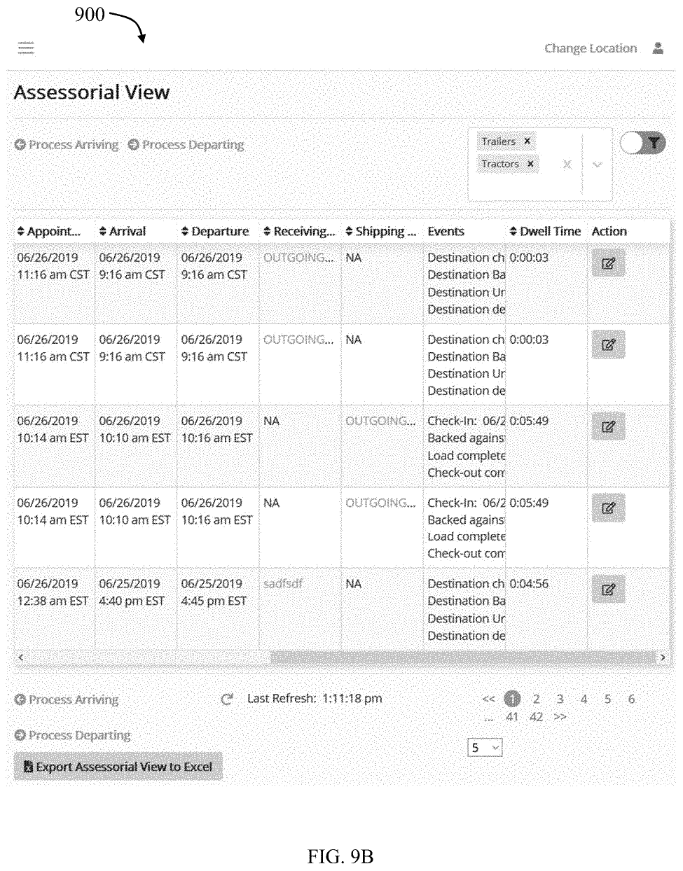

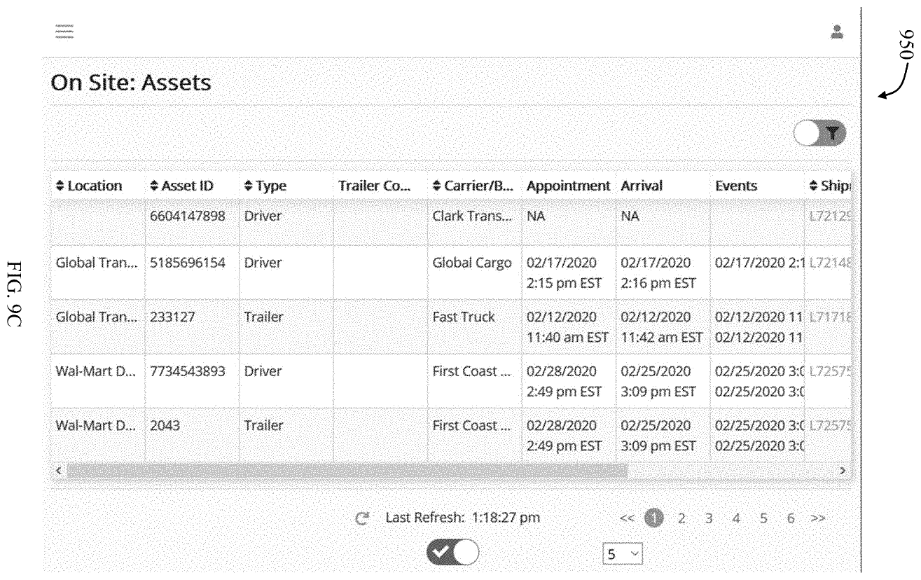

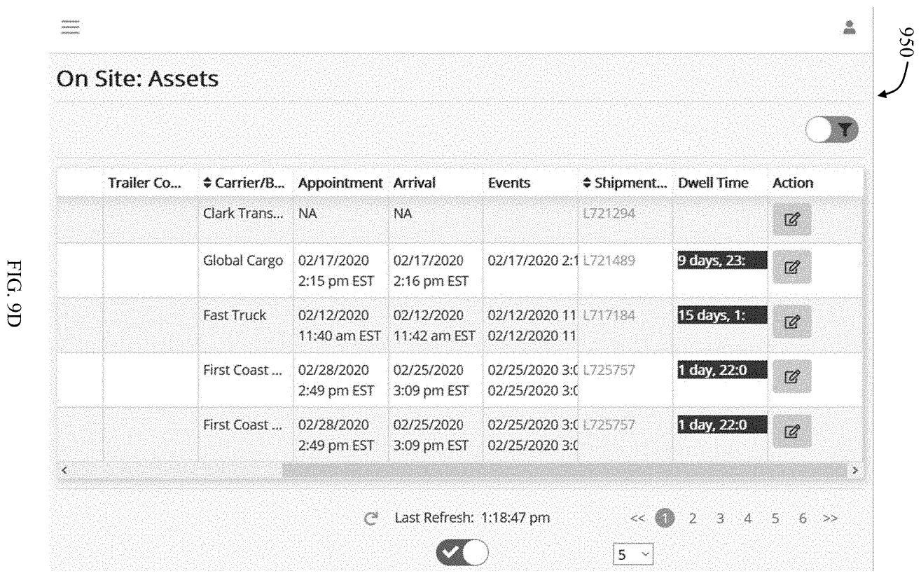

FIGS. 9A-9B illustrate an exemplary display 900 generated by the system. The system and method according to an embodiment of the present invention includes an assessorial validation module generating assessorial views and displays. A logged-in user accesses an “assessorial validation” view or assessorial display (e.g., on the app and/or web browser) comprised of a record for each unique excursion(s) of an asset(s) that match the search or filter criteria entered by the user. The UI display presents carrier and asset ID info, any associated shipment reference numbers, the event timestamps captured for the excursion, the total dwell time and, optionally, the recommended assessorial time and charge (as determined using business rules stored in a database in the storage medium). The system may include default rules and/or custom business rules may be entered by the shipper and added to the database.

The display 900 may provide a list view of the completed excursion of assets (i.e., assets that have arrived and departed a location) so that a user can see the actual dwell time (check-out timestamp minus check-in timestamp). The dwell time can be adjusted, automatically by the system, for any wait time at the check-in gate (as entered on the check-in template) or any on-site detention time that was not caused by the site, such as a driver taking break time or waiting to receive instructions for his next load (as entered on the check-out template).

The calculation and payment of unplanned assessorial charges is a significant problem in the industry. If a shipper does not preapprove any amount of assessorial charges, every invoice must be carefully reviewed and approved. When the shipper preapproves a fixed amount for assessorial charges, some carriers charge up to the excess amount on every shipment. With the present invention, assessorial charges can be easily determined and verified by both sides saving time and avoiding errors and overcharging. The dwell times, determined by the time stamps, can be converted by the system into an “approved assessorial charge” by applying the business rules and charge costs entered by a user representing the location or using default business rules. This approved assessorial charge can be viewed by the carrier via the system so that they submit an invoice for exactly this “pre-approved” amount without dispute or delay. Carriers can also use events, such as Delivered at Destination, to auto-trigger the invoice for the entire shipment, line haul charge included. Shippers can cost-effectively validate the carrier's assessorial invoices and automate the process of issuing payment using a match-pay process based on the indisputable dwell time data to calculate an approved assessorial charge and automatically issue payment to the carrier if the carrier's assessorial invoice did not exceed the approved amount. In some embodiments, an invoice is not even needed (e.g., generated for internal purposes only but not sent, or not generated at all). The party responsible for paying the charge can simply trigger payment for the “pre-approved” amount. A user may use the displayed data to validate and approve/deny the assessorial invoice submitted by the carrier. The user can document their actions and decisions by entering a note for the record. Alternatively, the user may review, optionally edit, and approve the record via a web browser, software application or app. Payment may then be processed (for, by example, by a third-party processor) for an assessorial invoice only if it matches the record in the system (within agreed tolerance). Alternatively, the user may export the displayed records to an output file (such as a csv text or an Excel file) and complete their review off-line.

A carrier user can view or export the displayed records and use the data to generate an assessorial invoice that will be acceptable to the shipper. Or, records can be transmitted by electronic means (such as API) from the system to the carrier's transaction system (such as QuickBooks) for systematic invoice generation.

The system and method also provide for cycle time analysis. Similarly, the user may export the displayed records to an output file (such as a csv text file or an Excel file) and analyze the cycle times off-line to identify the process bottlenecks that must be addressed to reduce dwell times to reduce or eliminate detention or demurrage charges.

FIGS. 9C-9D illustrate another interactive display 950 generated by the system. A logged-in user can access an “On-Site Assets” display comprised of a record for each unique asset (e.g., trailers) that match the search or filter criteria entered by the user. The display 950 presents a list view of on-site assets so that a user has visibility to current time on-site and can act on assets that are at-risk of incurring detention or demurrage assessorial charges. Carriers can also access the display 950 to monitor their assets at a site for the purpose of managing trailer pools or making decisions about removing equipment (loaded trailers for a shipment or empty trailers after unloading). The display 950 presents carrier and asset ID info, any associated shipment reference numbers, the event timestamps captured for the excursion, the cumulative dwell time and, optionally, the recommended assessorial time and charge which could be ZERO if the carrier is not eligible for assessorial charges (as determined using the business rules entered by the shipper into the system).

In some embodiments, the present invention may also provide for tracking trailers and shipments independent from the associated tractor and/or driver. A trailer tracking device may be removably attached inside one or a plurality of trailers and transmit real-time position signals for use by the system. The device is preferably battery operated and reconfigurable over-the-air. Applicant's U.S. Pat. No. 7,385,500, incorporated herein by reference, describes duplex devices which can be reconfigured remotely. In the present invention, the devices are reconfigurable according to the indisputable time stamps generated by the system. The trailer tracker can be turned on and off remotely and it's reporting intervals can be increased and decreased depending on the state of the trailer and shipment (e.g., in transit, parked, etc.) which improves the accuracy of the tracking data and preserves battery life. In some embodiments, the trailer tracker device may also reconfigure in response to entering or leaving a geofence. In some embodiments, the trailer tracking device receives signals from cellular towers and/or Wi-Fi hot spots (so-called reverse geo-location, which requires less power than GPS) to determine location. Furthermore, reverse geo-location enables the device to be mounted inside the trailer. Data from the trailer tracker devices is received by the system (via cellular communication) and displayed to users, such as shippers, in a map or list display in an asset tracking portion of the interactive displays. Historical data may also be received and displayed to see where a trailer is, where it has been, and how long it has been idle. The trailer tracking devices can also be used on other assets, such as dumpsters.

In some embodiments, the system and process may be used without the check-in and check-out applications or templates. For example, the event-by-text process (or event-by-browser/URL link described above) can be initiated by a carrier or a broker for any shipment when the shipment is dispatched to the driver, even if the origin ship location for the shipment is not using the check-in/check-out templates. Event and tracking data can be viewed by users at any company associated with the shipment (seller/shipper, buyer/receiver, carrier, broker).

In such embodiments, the carrier/broker triggers tracking when the driver and assets are assigned to and dispatched onto the shipment. The carrier/broker populates a simple template on an internet web-site application or submits shipment details to the system via an API from their TMS system. The system initiates a text message to the driver and tracking begins as described above. Tracking begins on dispatch providing visibility to the assets while in route to the ship from (origin) location for pick-up. The driver can trigger “no-touch” check-in at the origin. In such embodiments it is not necessary for the location to manually complete the arrival process. The truck's location may be validated via location services on the driver's device 120 or by replying with a changeable location code that is only known to the driver on arrival (e.g. displayed in gate house window). Events and tracking then continue for the balance of the shipment. Event and tracking data can be viewed in real-time by any user (whose company is associated with the shipment). The driver does not need to use a broker's app and now has a single app that allows him to transact with any broker. Data quality is enhanced, and any shipment can be tracked.

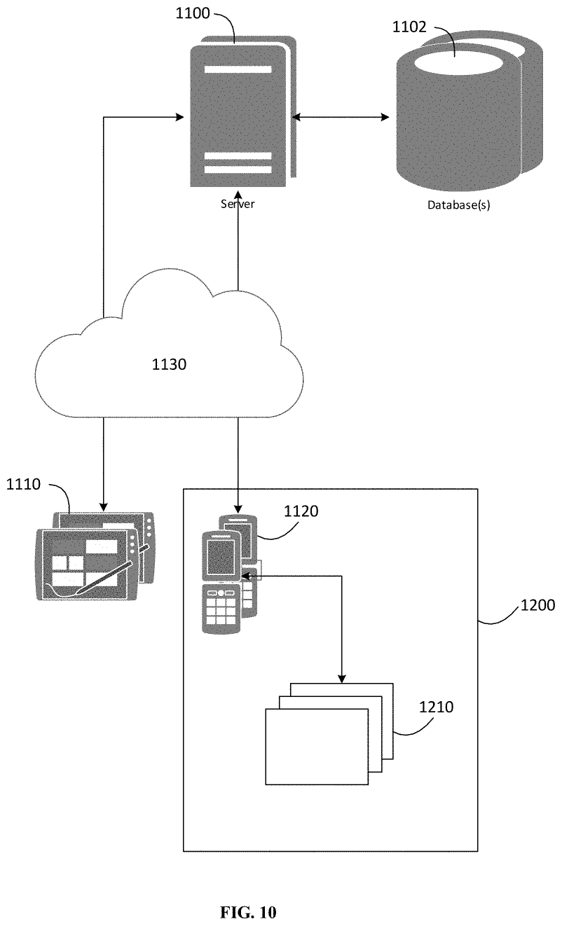

FIG. 10 illustrates another system according to an exemplary embodiment of the present invention. As with the system shown in FIG. 1, this embodiment includes at least one server 1100, at least one computer readable storage medium 1102, and one or more computing devices 1110, such as a personal computer, mobile device or tablet. The system further includes a plurality of mobile devices or phones 1120 associated with drivers of transportation assets 1200, such as trucks and/or trailers. The computing devices 1110 and mobile devices or phones 1120 are in communication with the system and the server 1100 thereof via a network 1130 such as the Internet and/or a cellular network 1140.

In the exemplary embodiment, the system communicates with one or a plurality of sensors 1210 in the transportation asset 1200. The sensors 1210 may include, but are not limited to, weight sensors, temperature sensors, humidity sensors, accelerometer/shock sensors, door position (open or closed) sensors, and trailer seal sensors, speed sensors, and fuel sensors. The driver's phone 1120 may communicate wirelessly with some or each of the sensors via a short-range wireless protocol. The exemplary embodiment employs Bluetooth Low Energy (BLE) to communicate between the phone 1120 and sensor(s) 1210 as pairing is not required with this protocol. Other protocols may include, but are not limited to, Bluetooth, Wi-Fi, RFID, and NFC.

The phone 1120 periodically or continuously reads the sensor's BLE advertised data or connects with the sensor(s) 1210 and reports sensor data to the system server 1100. The sensor data may then be transmitted to and/or displayed in the interactive displays described above. In the exemplary embodiment, the mobile phones 1120 access software executing on the server 1100 over the network 1130 via a website presented in a web browser, e.g., using the event-by-browser/URL link described above.

As discussed above, an initial text to the driver can include a URL link to a webpage that the driver can access on their mobile device 1120. The driver clicks through the events on the webpage as each task is completed. A timestamp associated with each event is recorded by the system. The system accesses the sensors 1210 via the Bluetooth functionality of the phone 1120 (or other shortrange wireless communication protocol) to collect sensor data and report the sensor data via the web browser along with an event timestamp. As discussed above, the system may also collect GPS location information from the phone 1120.

The sensor data may be collected periodically (e.g., at predetermined intervals), manually by the driver (e.g., at the departure point, destination, and/or in transit), or continuously. In a preferred embodiment, the web browser on the phone 1120 is configured (e.g., subject to the driver giving permission) to continuously or periodically receive and report the sensor data in the background regardless of whether the browser is open or the phone 1120 is unlocked. The sensor data is processed by the system and displayed in the interactive displays described above. In some embodiments, the system generates and displays alerts when the sensor data deviates from acceptable criteria. For example, if a sensor 1210 detects a trailer temperature above a predetermined temperature, an alert may be generated and displayed in the interactive displays.

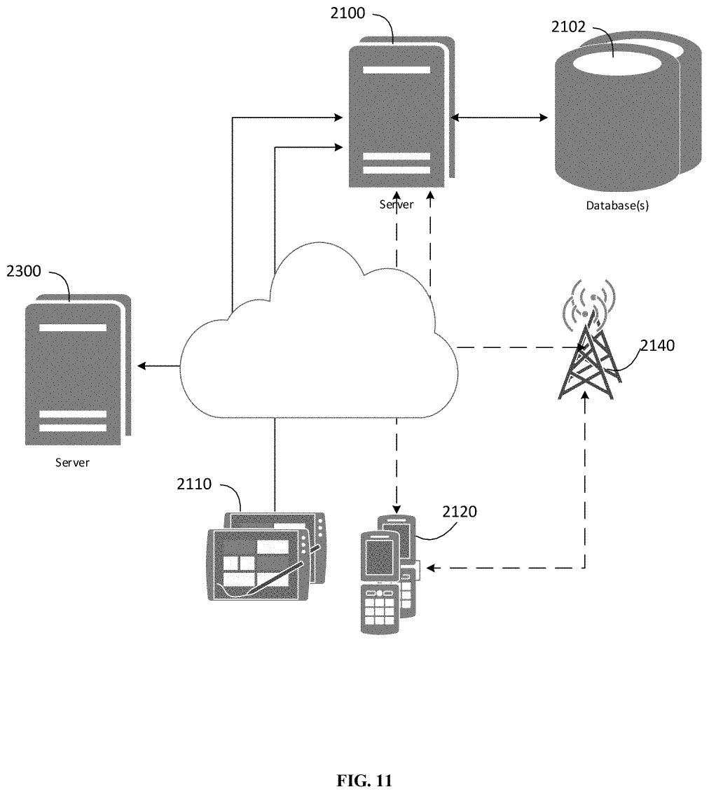

In some embodiments, event data generated by the system can be used to start, stop, pause/handoff tracking being performed in a different system. As shown in FIG. 11, the system (e.g., via server 2100) may communicate with one or more remote tracking systems. For example, the system may execute an API to communicate with or otherwise integrate with tracking systems that provide tracking data from various sources such as ELD's. The system may provide event data in real time to such tracking systems to provide accurate tracking data to their subscribers. Tracking systems are generally prone to inaccuracies because they do not know when to start and stop tracking of a vehicle. Using event data generated by the system, a tracking provider could start tracking on receipt of the “Arrived at First Stop” event by the driver and pause tracking on receipt of the “On Break” event by the driver and then stop tracking on receipt of the “Departed Final Stop” event by the driver. Doing so eliminates tracking “overhang” and protects the driver's privacy. Similarly, the tracking provider may switch from one device or app to another for a shipment on receipt of handoff events from a first driver and the next driver. This capability is especially useful to improve the quality of tracking data obtained from ELD devices.

The system according to the present invention may also include a “reverse Event by Message” functionality and tasks/workflow to facilitate the tracking of dray shipments. Using Truckload Dray (pick-up) to Rail to Truckload Dray (delivery) as an example, the process is as follows. First, the carrier dispatcher creates a group of shipments that will all be off-loaded from the rail at the destination rail siding at the same time and be ready for delivery to the destination location. The dispatcher then communicates this list of containers to the dray driver via their existing process. The dispatcher then associates the driver cell number and tractor number with the group of shipments. The dispatcher also enters the “off-loaded timestamp” for the group, which starts the demurrage clock. The driver receives an Event by Message text. The workflow allows the driver to initiate the process by entering the container number for the container that he has just connected to. The system echoes back the shipment details associated with the container for driver confirmation. If no matching shipment is found, then system requests that the driver enter a correct container number. Driver clicks an “I'm connected to the container” button and transmits the driver's location, e.g., based on a mobile phone GPS signal. Receiving the driver's location provides immediate visibility to the pick-up. Next, the system issues an Imminent Arrival alert to the receiver. If container is on the receiver's “I need it now list”, then the receiver prepares a dock to immediately unload the container (rather than just dropping it in the yard). The driver delivers the shipment, all the while executing the “event by message” process. The driver may then return for the next load. The process loops until all containers in the group are delivered. In some embodiments, receiving the driver's location provides the receiver with visibility to the group and the receiver can submit a priority order. The message to the driver requesting the entry of a container number would then first list “get them first” container numbers.

The present embodiment provides significant advantages over prior systems and methods to collect information concerning transportation assets. Sensor data is collected and transmitted in real time, and made available to any and all parties having an interest in the shipment, without the need for a dedicated mobile app. Some prior methods, such as for recording trailer temperature, require the driver to visit a service center and download trailer temperature data resulting in an additional cost and loss of time. Often the data is not available to the interested parties for hours, or even days.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated but fall within the scope of the appended claims.

What is claimed is:

1. A system for checking in and monitoring transportation assets, comprising:
a server including a processor and a computer readable storage medium;
a plurality of tasks stored on the storage medium, each task defining at least one automated message associated with a shipment event;
computer readable program instructions stored on the storage medium and read and executed by the processor to perform steps of:
receiving data indicative of a carrier vehicle and a shipment;
load a plurality of the tasks to generate a workflow for the shipment;
initiating, based on the workflow, a text message to a mobile device of a driver of the carrier vehicle;
receiving at least one text message from the driver of the carrier vehicle indicative of a confirmation of an event; and
recording at least one timestamp associated with the event confirmed by the at least one text message.

2. The system of claim 1, wherein the data indicative of the carrier vehicle and the shipment includes a shipment type, wherein the system loads one of a plurality of predefined workflows including a plurality of the tasks for the received shipment type.

3. The system of claim 1, wherein the step of receiving the data includes receiving the data via a template submitted by one of a dispatcher of the carrier vehicle, an attendant at a shipping location, or the driver of the carrier vehicle.

4. The system of claim 1, wherein the steps of receiving at least one text message from the driver and recording at least one timestamp include:
receiving a text message from the driver of the carrier vehicle indicative of a confirmation that the carrier vehicle is at a loading dock at a location;
recording a timestamp associated with the carrier vehicle being at the loading dock;
receiving a text message from the driver of the carrier vehicle indicative of a confirmation that the carrier vehicle is loaded or unloaded;
recording a timestamp associated with the carrier vehicle being loaded or unloaded;
receiving a text message from the driver of the carrier vehicle indicative of a confirmation that the carrier vehicle is departing the location; and
recording a timestamp associated with the carrier vehicle departing the location.

5. The system of claim 4, wherein the steps further include initiating a text message after check-out requesting the driver's remaining hours of service or requesting the driver's estimated time of arrival at a next location.

6. The system of claim 1, wherein the steps of receiving at least one text message from the driver and recording at least one timestamp include:
receiving a text message from the driver of the carrier vehicle indicative of a confirmation that a trailer is dropped off for loading or unloading; and
recording a timestamp associated with the trailer being dropped off.

7. The system of claim 1, wherein the steps of receiving at least one text message from the driver and recording at least one timestamp include:
receiving a text message from the driver of the carrier vehicle indicative of a confirmation that a trailer is picked up from the location; and
recording a timestamp associated with the trailer being picked up.

8. The system of claim 1, further comprising an application accessible on a computing device at a location, the application presenting a check-in template on a user interface of the computing device and receiving, via the template, the data indicative of the carrier vehicle arriving at the location in the form of a user input.

9. The system of claim 8, wherein the application further presents a check-out template and receives, via the check-out template, data indicative of the carrier vehicle being checked out.

10. The system according to claim 9, wherein the check-in and the check-out templates include a plurality of fields at least a portion of which are prepopulated by the system.

11. The system of claim 1, further comprising an application executing on a computing device of a dispatcher, the application presenting a dispatch template on a user interface of the computing device and receiving, via the template, the data indicative of the carrier vehicle being dispatched to a location in the form of a user input.

12. The system of claim 1, wherein each of the text messages are an SMS communicated over a cellular network.

13. The system of claim 1, wherein each of the text messages are a data message, wherein at least a portion of the data messages include location data associated with the mobile device of the driver.

14. The system of claim 13, wherein the data message is encrypted.

15. The system of claim 1, wherein the text message initiated to the mobile device of the driver of the carrier vehicle upon receiving data indicative of a carrier vehicle arriving at a location includes a URL link to a webpage to receive responses from the driver, wherein the text messages from the driver are sent over the Internet via the webpage.

16. The system of claim 15, wherein the text messages sent via the webpage include location data from the mobile device of the driver.

17. The system of claim 1, further comprising software executing on the server generating and displaying one or more interactive displays of the at least one timestamp to at least one of a carrier, a shipper, or a third party associated with assets of the shipment.

18. The system of claim 17, wherein the interactive displays present data indicative of dwell times of assets at at least one location, including one or more trucks or trailing equipment.

19. The system of claim 18, wherein the dwell times are automatically adjusted for wait time at the check-in gate and/or any wait time not caused by the location.

20. The system of claim 18, wherein the system converts the dwell times into approved assessorial charges and displays the approved assessorial charges in the interactive displays for payment.

21. The system of claim 18, wherein the computer readable program instructions further include steps of calculating an approved charge for an unplanned assessorial, comparing a carrier's charge for the unplanned assessorial to the approved charge, and systematically triggering payment if the carrier's charge does not exceed the approved charge.

22. The system of claim 1, wherein the steps further include a step of handing off the shipment to a second driver including receiving a text message from the driver including a mobile number of the second driver, initiating, based on the workflow, a text message to a mobile device of the second driver of the carrier vehicle.

23. The system of claim 1, wherein the steps further include a step of initiating, based on the workflow, a text message to the mobile device of the driver of the carrier vehicle a list of containers at a location, wherein the system associates the driver with each of the containers, and wherein the steps further include a step of receiving a text message from the driver of the carrier vehicle including a container number of a first one of the containers connected to the carrier vehicle.

24. The system of claim 1, further comprising software executing on said server for transmitted data indicative of the event to a third party tracking system, wherein the third party tracking system initiates or discontinues tracking of the carrier vehicle based on the data indicative of the event.

25. The system of claim 1, further comprising:
at least one sensor in the carrier vehicle in wireless connectivity with the mobile device;
wherein the mobile device receives sensor data from the at least one sensor;
wherein the steps performed by the computer readable program includes receiving the sensor data from the mobile device.

26. The system of claim 25, wherein each of the text messages are a data message, wherein the text message initiated to the mobile device of the driver of the carrier vehicle upon receiving data indicative of a carrier vehicle arriving at a location or being dispatched to a location includes a URL link to a webpage to receive responses from the driver, wherein the sensor data is sent over the Internet via the webpage.

27. The system of claim 1, wherein the carrier vehicle includes a trailer having a trailer tracking device periodically sending location information of the trailer which is received by the system, wherein the trailer tracking device is remotely reconfigurable according to the at least one time stamp.

28. A method for checking in and monitoring transportation assets, comprising steps of:
receiving, via an application executing on a computing device, a user input indicative of a carrier vehicle dispatched to or arriving at a location;
selecting a predefined, or generating a custom, workflow;
initiating a text message based on the workflow to a mobile device of a driver of the carrier vehicle, wherein the text message prompts the driver to confirm that the carrier vehicle is engaging in a first event at the location;
receiving a responsive text message from the mobile device of the driver indicative of a confirmation that the carrier vehicle is engaging in the first event at the location;
recording a timestamp associated with the carrier vehicle engaging in the first event;
prompting, via a text message to the mobile device of the driver, the driver to confirm that the carrier vehicle is engaging in a second event;
receiving a responsive text message from the mobile device of the driver indicative of a confirmation that the carrier vehicle is engaging in the second event; and
recording a timestamp associated with the carrier vehicle engaging in the second event.

29. The method of claim 28, wherein the application executing on the computing device is a browser application presenting a template to one of a dispatcher of the carrier vehicle, an attendant at the location, or the driver of the carrier vehicle.

30. The method of claim 28, wherein the first event is being positioned at a loading dock for loading or unloading at the location and the second event is departing the location.

31. The method of claim 30, wherein the method further comprises a step of initiating a text message to the mobile device of the driver of the carrier vehicle prompting the driver to confirm that the carrier vehicle has arrived at the location.

32. The method of claim 30, further comprising the steps of:
prompting, via a text message to the mobile device of the driver, the driver to confirm that the carrier vehicle is loaded;
receiving a responsive text message from the mobile device of the driver indicative of the carrier vehicle being loaded;
recording a timestamp associated with the carrier vehicle being loaded.

33. The method of claim 30, further comprising the steps of:
prompting, via a text message to the mobile device of the driver, the driver to confirm that the carrier vehicle is unloaded;
receiving a responsive text message from the mobile device of the driver indicative of the carrier vehicle being unloaded;
recording a timestamp associated with the carrier vehicle being unloaded.

34. The method of claim 28, further comprising steps of:
prompting, via a text or voice message to the mobile device of the driver, the driver to provide the driver's remaining hours of service; and
receiving, via a responsive text or voice message from the mobile device of the driver, user input indicative of driver's remaining hours of service.

35. The method of claim 28, further comprising steps of:
prompting, via a text or voice message to the mobile device of the driver, the driver to confirm arrival at a destination; and
receiving, via a responsive text or voice message from the mobile device of the driver, user input indicative of a confirmation of arrival at the destination.

36. The method of claim 35, further comprising steps of:
prompting, via a text or voice message to the mobile device of the driver, the driver to confirm departure from the destination; and
receiving, via a responsive text or voice message from the mobile device of the driver, user input indicative of a confirmation of the departure from the destination.

37. The method of claim 35, further comprising steps of:
prompting, via a text message to the mobile device of the driver, the driver to provide and image indicating proof of delivery; and
receiving, via a responsive text message from the mobile device of the driver, the image indicating proof of delivery.

38. The method of claim 35, further comprising steps of:
prompting, via a text message to the mobile device of the driver, the driver to identify an overage, shortage or damage (OSD) issue;
receiving, via a responsive text message from the mobile device of the driver, the identification of an OSD issue; and
initiating an OSD ticket for action and/or resolution by a shipper.

39. The method of claim 35, further comprising steps of:
prompting, via a text message to the mobile device of the driver, the driver to confirm arrival at a second destination; and
receiving, via a responsive text message from the mobile device of the driver, user input indicative of a confirmation of arrival at the second destination;
prompting, via a text or voice message to the mobile device of the driver, the driver to confirm departure from the second destination; and
receiving, via a responsive text or voice message from the mobile device of the driver, user input indicative of a confirmation of the departure from the second destination.

40. The method of claim 28, wherein the text message initiated to the mobile device of the driver of the carrier vehicle upon receiving data indicative of a carrier vehicle arriving at a location includes a URL link to webpage to receive responses from the driver, wherein the text messages from the driver are sent via the webpage.

41. The method of claim 28, further including a step of handing off the shipment to a second driver including receiving a text message from the driver including a mobile number of the second driver, initiating, based on the workflow, a text message to a mobile device of the second driver of the carrier vehicle.

42. The method of claim 28, further including a step of initiating, based on the workflow, a text message to the mobile device of the driver of the carrier vehicle a list of containers at a location, wherein the system associates the driver with each of the containers, and wherein the method further includes a step of receiving a text message from the driver of the carrier vehicle including a container number of a first one of the containers connected to the carrier vehicle.

43. A computer readable storage medium having computer readable program instructions, the computer readable program instructions read and executed by at least one processor for performing the method of claim 28.

44. A system for checking in and monitoring transportation assets, comprising:
a server including a processor and a computer readable storage medium;
a plurality of tasks stored on the storage medium for executing workflows;
computer readable program instructions stored on the storage medium and read and executed by the processor for performing steps of:
receiving data indicative of a carrier vehicle and a shipment;
loading a workflow including two or more of the plurality of tasks;
initiating a message, based on the workflow, to a mobile device of a driver of the carrier vehicle, the message including a URL link to a webpage to receive messages from the driver and data from the carrier vehicle;
receiving at least one message from the driver of the carrier vehicle via the webpage indicative of a confirmation of an event; and
recording at least one timestamp associated with the event confirmed by the at least one message.

45. The system of claim 44, wherein the data received from the carrier vehicle includes sensor data, wherein the mobile device wirelessly connects to at least one sensor in the carrier vehicle, wherein the mobile device receives the sensor data from the at least one sensor and transmits the sensor data via the webpage to the server.

46. The system of claim 45, wherein at least one sensor is one of a temperature sensor, a humidity sensor, a shock sensor, a light sensor or a door position sensor.

47. The system of claim 45, further comprising software executing on the server processing the sensor data and generating one or more interactive displays of the processed sensor data wherein the interactive displays are accessible via the Internet.

48. The system of claim 45, further comprising software executing on the server generating an alert when a value in the sensor data is outside of a predetermined value range.
